(19) United States
(12) Patent Application Publication
(10) Pub. No.: US 2025/0350119 A1
(43) Pub. Date: Nov. 13, 2025

(54) POWER ADJUSTMENT DEVICE

(71) Applicant: NTT DOCOMO, INC., Tokyo (JP)

(72) Inventors: Fumiya KOMATSU, Chiyoda-ku (JP); Difei MIYAO, Chiyoda-ku (JP); Kazuhiko TAKENO, Chiyoda-ku (JP)

(73) Assignee: NTT DOCOMO, INC., Tokyo (JP)

(21) Appl. No.: 18/871,709

(22) PCT Filed: May 8, 2023
(86) PCT No.: PCT/JP2023/017318

§ 371 Date: Dec. 4, 2024

(30) Foreign Application Priority Data
Jun. 6, 2022 (JP) 2022-091521

(51) Int. Cl. H02J 3/28; H02J 3/00; H02J 7/00

(52) U.S. Cl. CPC H02J 3/28; H02J 3/0012; H02J 3/003; H02J 3/004; H02J 7/00712; H02J 2203/10

(57) ABSTRACT

The power supply and demand balance is appropriately adjusted. A power adjustment device 1 is a power adjustment device 1 that adjusts a power supply and demand balance in a power system including one or more power devices each of which is at least one of a storage battery and a load. The power adjustment device 1 includes a setting unit 13 that sets at least one of the power devices as a target power device, for which operation control related to power is possible, based on the supply and demand balance predicted and an adjustment unit 14 that adjusts the supply and demand balance by controlling an operation of the target power device.

### TECHNICAL FIELD

One aspect of the present disclosure relates to a power adjustment device that adjusts a power supply and demand balance.

### BACKGROUND ART

The following Patent Literature 1 discloses an independent power supply system that calculates demand forecast data for a load device and power generation output forecast data for a natural energy power generator using weather forecast data and that suppresses the power generation output from the natural energy power generator when it is predicted that the storage battery will be charged beyond its maximum charge power based on the demand forecast data and the power generation output forecast data and suppresses the power consumption of an adjustment load when it is predicted that the storage battery will be discharged beyond its maximum discharge power based on the demand forecast data and the power generation output data.

### CITATION LIST

### Patent Literature

Patent Literature 1: Japanese Unexamined Patent Publication No. 2013-176234

### SUMMARY OF INVENTION

### Technical Problem

In the independent power supply system described above, the storage battery for the charging and discharging of power and the adjustment load that adjusts power consumption are fixed. For this reason, it may not be possible to appropriately adjust the power supply and demand balance. Therefore, there is a demand for technology that can appropriately adjust the power supply and demand balance.

### Solution to Problem

A power adjustment device according to one aspect of the present disclosure is a power adjustment device for adjusting a supply and demand balance of power in a power system including one or more power devices each of which is at least one of a storage battery and a load, and includes: a setting unit that sets at least one of the power devices as a target power device, for which operation control related to power is possible, based on the supply and demand balance predicted; and an adjustment unit that adjusts the supply and demand balance by controlling an operation of the target power device.

According to this aspect, it is possible to set target power devices whose operations are to be controlled in order to adjust the supply and demand balance, based on the predicted power supply and demand balance. Therefore, it is possible to appropriately adjust the power supply and demand balance.

### Advantageous Effects of Invention

According to one aspect of the present disclosure, it is possible to appropriately adjust the power supply and demand balance.

### BRIEF DESCRIPTION OF DRAWINGS

FIG. 1 A diagram showing an example of the system configuration of a power system including a power adjustment device according to an embodiment.

FIG. 2 A diagram showing an example of the functional configuration of the power adjustment device according to the embodiment.

FIG. 3 A flowchart showing an example of processing performed by the power adjustment device according to the embodiment.

FIG. 4 A flowchart showing an example of the processing performed by the power adjustment device according to the embodiment.

FIG. 5 A diagram showing an example of a table of power data.

FIG. 6 A diagram showing an example of a table of weather forecast data.

FIG. 7 A diagram showing an example of a table of time data.

FIG. 8 A diagram showing an example of a table of day-of-the-week data.

FIG. 9 A diagram showing an example of a table of holiday data.

FIG. 10 A diagram showing various zones from which people flow data is acquired.

FIG. 11 A diagram showing an example of a table of people flow data in an industrial zone.

FIG. 12 A diagram showing an example of a table of people flow data in a low-rise building zone.

FIG. 13 A diagram showing an example of a table of people flow data in a mixed building zone.

FIG. 14 A diagram showing an example of a table of people flow data in a dense low-rise building zone.

FIG. 15 A diagram showing an example of a table of people flow data in a high-rise building zone.

FIG. 16 A diagram showing an example of a table of people flow data in the other building zone.

FIG. 17 A diagram showing an example of a neural network model used to predict demand power.

FIG. 18 A diagram showing an example of a table of supply power data.

FIG. 19 An example of a table showing demand power, upper limit values, and lower limit values.

FIG. 20 A graph showing abnormality values when overdemand for power is predicted.

FIG. 21 A graph showing abnormality values when the oversupply of power is predicted.

FIG. 22 A diagram showing an example of a table of abnormality value data.

FIG. 23 A diagram showing another example of a table of abnormality value data.

FIG. 24 A diagram showing an example of a control determination flag.

FIG. 25 A diagram showing an example of a table of data related to a storage battery.

FIG. 26 A graph showing the relationship between demand power and supply power when overdemand for power is predicted.

FIG. 27 A diagram showing an example of a control determination flag.

FIG. 28 A diagram showing an example of resetting the controllability flag of a storage battery.

FIG. 29 A graph showing the relationship between demand power and supply power when the oversupply of power is predicted.

FIG. 30 A diagram showing an example of a control determination flag.

FIG. 31 A diagram showing an example of a table of data related to a load.

FIG. 32 A diagram showing an example of resetting the controllability flag of a load.

FIG. 33 A diagram showing an example of controllability flags of a storage battery and a load.

FIG. 34 A diagram showing input to and output from a power adjustment device.

FIG. 35 A diagram showing an example of the hardware configuration of a computer used in the power adjustment device according to the embodiment.

### DESCRIPTION OF EMBODIMENTS

Hereinafter, embodiments of the present disclosure will be described in detail with reference to the diagrams. In addition, in the description of the diagrams, the same elements are denoted by the same reference numerals, and repeated description thereof will be omitted. In addition, the embodiments of the present disclosure in the following description are specific examples of the present invention, and the present invention is not limited to these embodiments unless there is a statement that specifically limits the present invention.

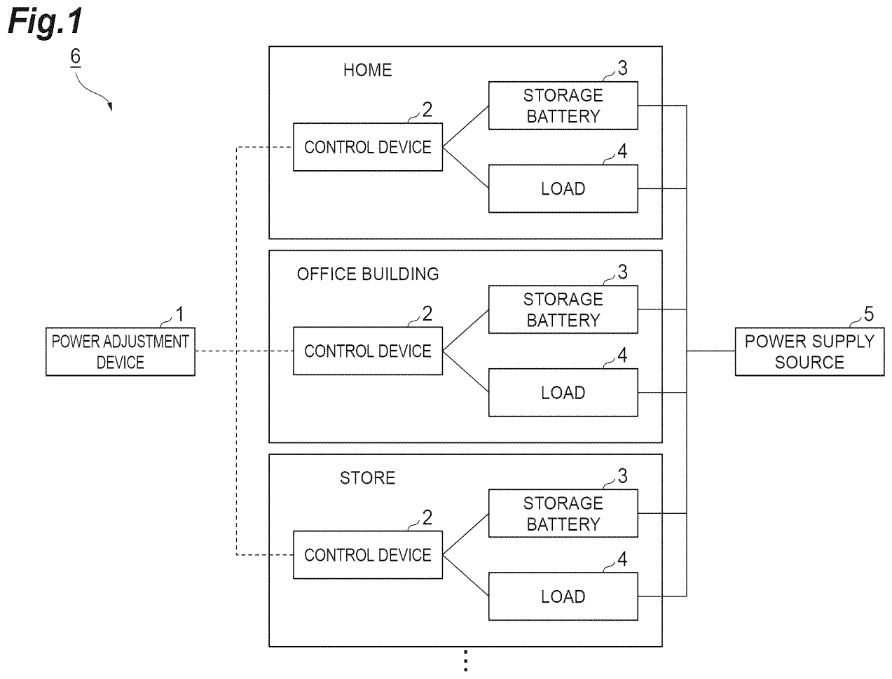

FIG. 1 is a diagram showing an example of the system configuration of a power system including a power adjustment device according to an embodiment. As shown in FIG. 1, a power system 6 includes a power adjustment device 1, one or more control devices 2, one or more storage batteries 3, one or more loads 4, and one or more power supply sources 5. In the present embodiment, a plurality of control devices 2, a plurality of storage batteries 3, a plurality of loads 4, and a plurality of power supply sources 5 will be collectively referred to simply as “control device 2”, “storage battery 3”, “load 4”, and “power supply source 5”, respectively, as appropriate. The control device 2, the storage battery 3, and the load 4 are provided, for example, in a customer facility. The customer facility may be a home, an office building, a store, or other facilities. The power system 6 includes one or more power devices. The power device is at least one of the storage battery 3 and the load 4. In the example shown in FIG. 1, the power system 6 includes one or more power devices. In the present embodiment, a plurality of power devices will be collectively referred to simply as “power device” as appropriate.

The power adjustment device 1 adjusts a power supply and demand balance in the power system 6. The power supply and demand balance is the relationship, equilibrium, balance, or harmony between the power that is scheduled to be supplied to the power system 6 (supply power) and the power that is predicted to be demanded in the power system 6 (demand power). The supply power may be, for example, power provided by a power supply source 5. The demand power may be, for example, the power consumed by the load 4. The power adjustment device 1 will be described in detail later.

The control device 2 is communicably connected to the power adjustment device 1, and controls the operation of the power device based on a control command received from the power adjustment device 1. For example, the control device 2 controls the charging and discharging of the storage battery 3 and the operating state of the load 4 based on a control command received from the power adjustment device 1. The control of the operating state of the load 4 includes not only control for activating the load 4 and control for deactivating the load 4 but also control for changing the output of the load 4.

The storage battery 3 is a power device that performs charging and discharging of power. The storage battery 3 is electrically connected to the power supply source 5 and accordingly, can be charged with power supplied from the power supply source 5. In addition, the storage battery 3 is electrically connected to the load 4 and accordingly, can discharge the power charged in itself to supply the power to the load 4.

The load 4 is a power device that consumes power for its own operation. The load 4 can be operated by power supplied from the power supply source 5 and power supplied from the storage battery 3. The load 4 may be, for example, an air conditioner, a lighting device, or OA equipment.

The power supply source 5 is a source of power supplied to the power system 6. The power supplied from the power supply source 5 is consumed, for example, in the load 4. The power supplied from the power supply source 5 may be charged into the storage battery 3. The power supply source 5 may be, for example, a commercial power source. When the power supply source 5 is a commercial power source that generates AC current, the power system 6 may further include a rectifier (not shown) that converts the AC power from the power supply source 5 into DC power and outputs the DC power. The power system 6 may further include a smart meter. The smart meter is a power meter that can measure the power consumption in the power system 6 and transmit the measured data to a remote device (for example, a server of a power supplier that manages the power supply source 5) using the device's own communication function.

An overview of processing for adjusting the power supply and demand balance by the power adjustment device 1 will be described. First, the power adjustment device 1 predicts the power supply and demand balance for a future target period. The power adjustment device 1 predicts the power supply and demand balance based on, for example, a difference between demand power and supply power. The supply and demand balance prediction process will be described in detail later.

When it is predicted that an abnormality in the power supply and demand balance will occur, the power adjustment device 1 performs operation control related to the power of the target power device in the period in which the abnormality is predicted to occur. The term “target power device” refers to a power device for which operation control related to power is possible, and is used to adjust the supply and demand balance. “Operation control related to the power of the target power device” refers to control for adjusting the power supply and demand balance. For example, “operation control related to the power of the target power device” refers to control related to discharging or charging of the storage battery 3 when the power device is the storage battery 3, and refers to control of the operating state of the load 4 when the power device is the load 4. The power adjustment device 1 sets a target power device among a plurality of power devices based on the predicted supply and demand balance. For example, the power adjustment device 1 sets a target power device among a plurality of power devices so that the abnormality in the supply and demand balance can be resolved. The process of setting the target power device will be described in detail later.

When overdemand for power is predicted, the power adjustment device 1 transmits to the control device 2 at least one of a control command to discharge the storage battery 3 set as a target power device in the period in which overdemand is predicted and a control command to deactivate the load 4 set as a target power device. In contrast, when the oversupply of power is predicted, the power adjustment device 1 transmits to the control device 2 at least one of a control command to charge the storage battery 3 set as a target power device and a control command to activate the load 4 set as a target power device in the period in which the oversupply is predicted. The control device 2 adjusts the supply and demand balance by controlling the storage battery 3 and the load 4 based on the control command received from the power adjustment device 1, thereby avoiding the occurrence of an abnormality in the supply and demand balance.

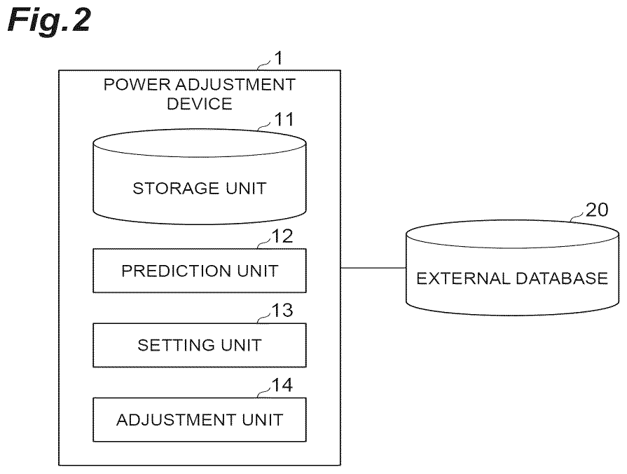

FIG. 2 is a diagram showing an example of the functional configuration of the power adjustment device according to the embodiment. As shown in FIG. 2, the power adjustment device 1 includes a storage unit 11, a prediction unit 12, a setting unit 13, and an adjustment unit 14.

Each functional block of the power adjustment device 1 is assumed to function within the power adjustment device 1, but the present invention is not limited thereto. For example, some of the functional blocks of the power adjustment device 1 may function within a computer device, which is different from the power adjustment device 1 and is connected to the power adjustment device 1 through a network, while appropriately transmitting and receiving information to and from the power adjustment device 1. In addition, some of the functional blocks of the power adjustment device 1 may be omitted, a plurality of functional blocks may be integrated into one functional block, or one functional block may be divided into a plurality of functional blocks.

Hereinafter, each function of the power adjustment device 1 shown in FIG. 2 will be described.

The storage unit 11 stores any information used in the calculations and the like in the power adjustment device 1, results of the calculations in the power adjustment device 1, and the like. The information stored in the storage unit 11 may be referred to by each functional element of the power adjustment device 1 as appropriate.

The prediction unit 12 predicts the power supply and demand balance in the power system 6. The prediction unit 12 predicts the supply and demand balance based on, for example, demand power and supply power.

The setting unit 13 sets at least one power device among the power devices included in the power system 6, as a target power device, based on the predicted supply and demand balance.

When the occurrence of an abnormality in the supply and demand balance is predicted, the setting unit 13 may set the target power device so that the abnormality in the supply and demand balance can be resolved.

The setting unit 13 may set the target power device so that the adjustment power amount that can be adjusted by controlling the operation of the target power device is equal to or greater than the differential power amount, which is the difference between the supply power scheduled to be supplied to the power system 6 and the demand power predicted to occur in the power system 6.

The setting unit 13 may set the target power device so that the difference between the adjustment power amount and the differential power amount is minimized.

The setting unit 13 may set the target power device based on at least one of the amount of power charged and discharged in the storage battery 3 and the amount of power consumed by the load 4.

The setting unit 13 may set one or more storage batteries 3 and one or more loads 4 as target power devices.

The setting unit 13 may determine whether or not to set the load 4 as a target power device based on the operating state of the load 4.

The setting unit 13 may set the target power device based on an instruction from the user of the power adjustment device 1.

The adjustment unit 14 adjusts the supply and demand balance by controlling the operation of the target power device. “Performing operation control of the target power device” includes not only a case where a control command is transmitted to the control device 2 and operation control of the target power device is indirectly performed through the control device 2 but also a case where operation control of the target power device is performed directly without the control device 2.

The power adjustment device 1 is communicably connected to an external database 20, and can acquire various kinds of data from the external database 20. The external database 20 may be, for example, a database of a power supplier or a database of a government agency or company that provides weather forecasting.

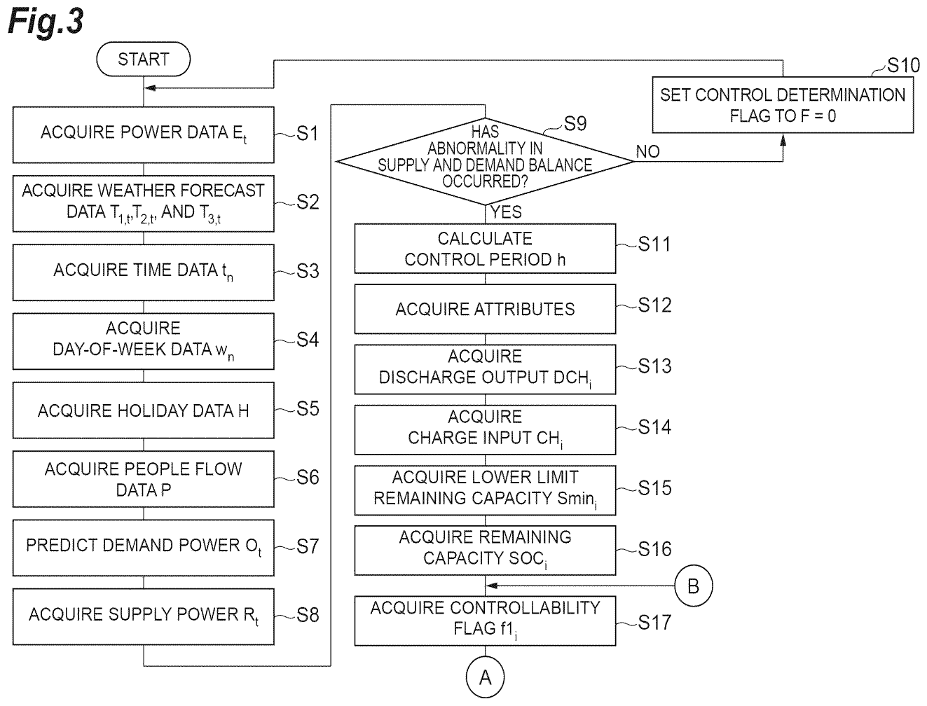

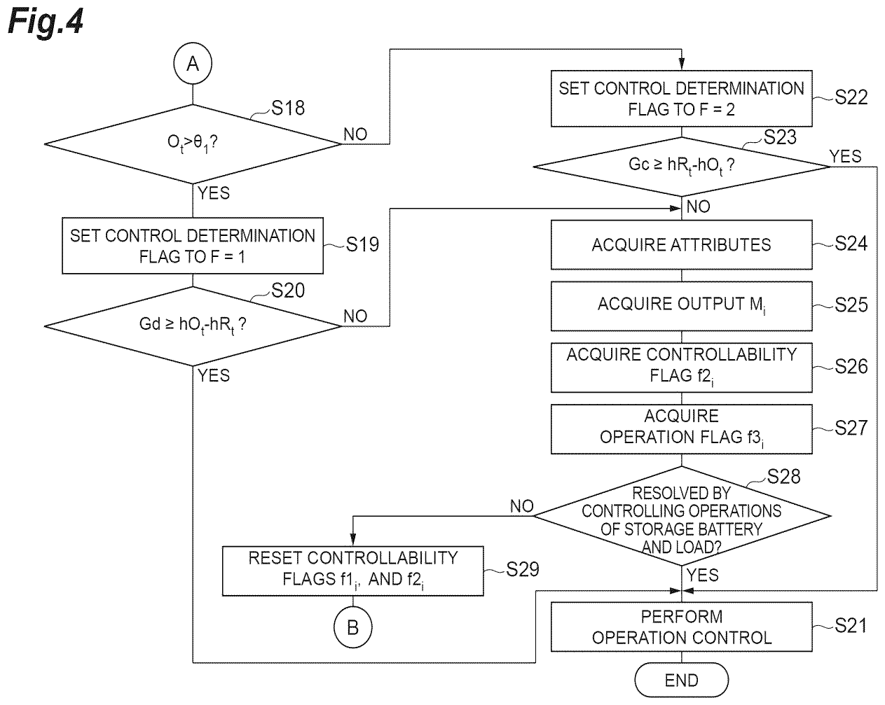

Next, an example of processing performed by the power adjustment device 1 will be described with reference to FIGS. 3 and 4. FIGS. 3 and 4 are flowcharts showing an example of processing performed by the power adjustment device according to the embodiment. The process shown in FIG. 4 is a process subsequent to circled A in FIG. 3.

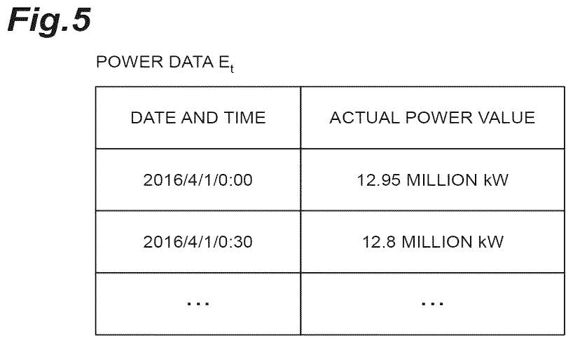

First, the prediction unit 12 acquires various kinds of data used for predicting demand power from the storage unit 11 (steps S1 to S6). Specifically, first, the prediction unit 12 acquires power data Eₜ from the storage unit 11 (step S1). The power data Eₜ is a measurement value (actual power value) of the power actually used in the past. The power data Eₜ may be measured, for example, by a smart meter and stored in the external database 20 (for example, a database of a power supplier). The power adjustment device 1 may acquire the power data Eₜ from the external database 20 in advance, and the storage unit 11 may store the acquired power data Eₜ. FIG. 5 is a diagram showing an example of a table of power data. In the example of the table of the power data Eₜ shown in FIG. 5, the date and time and the actual power value are associated with each other.

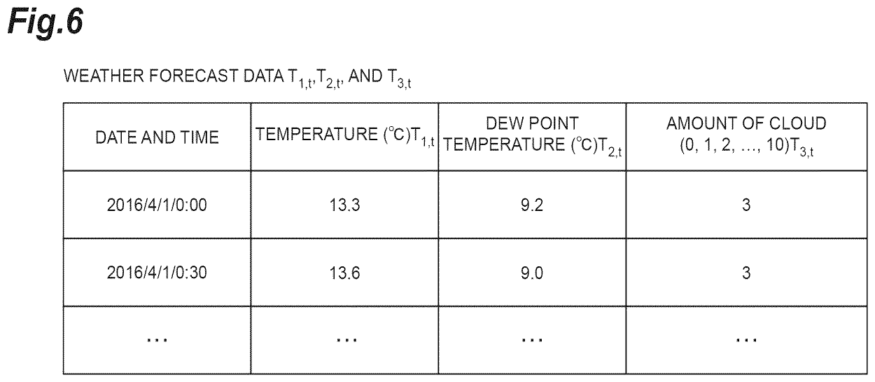

Then, the prediction unit 12 acquires weather forecast data from the storage unit 11 (step S2). The prediction unit 12 acquires, for example, past weather forecast data and weather forecast data for a future target period in which the power supply and demand balance is predicted. The past weather forecast data may be actual weather data in the past. The power adjustment device 1 may acquire weather forecast data in advance from the external database 20 (for example, a database of a government agency or company that performs weather forecasting), and the storage unit 11 may store the acquired weather forecast data. FIG. 6 is a diagram showing an example of a table of weather forecast data. In the example of the table of weather forecast data shown in FIG. 6, the date and time, temperature T_{1,t}, dew point temperature T_{2,t}, and the amount of cloud T_{3,t} are associated with each other. The amount of cloud is divided into 11 levels ranging from 0 to 10, with the closer to 10 the cloudiness.

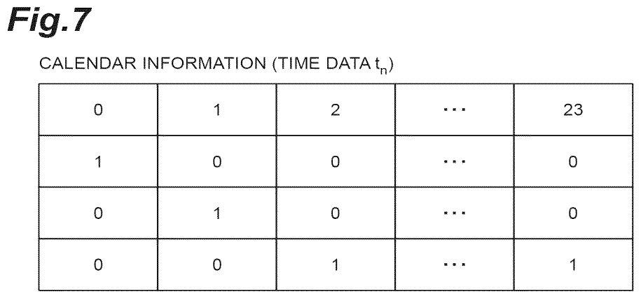

Next, the prediction unit 12 acquires time data tₙ from the storage unit 11 (step S3). FIG. 7 is a diagram showing an example of a table of time data. In the example of the table of the time data tₙ shown in FIG. 7, the time data tₙ is shown by a value expressed in 1 bit (in this example, “0” or “1”). The time data tₙ shown in FIG. 7 is data indicating the hour, but the time data tₙ may include data indicating the minute.

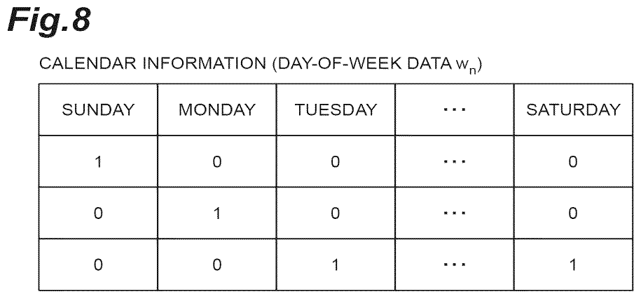

Then, the prediction unit 12 acquires day-of-the-week data Wₙ from the storage unit 11 (step S4). FIG. 8 is a diagram showing an example of a table of day-of-the-week data. In the example of the table of the day-of-week data Wₙ shown in FIG. 8, the day-of-week data Wₙ is shown by a value expressed in 1 bit (in this example, “0” or “1”).

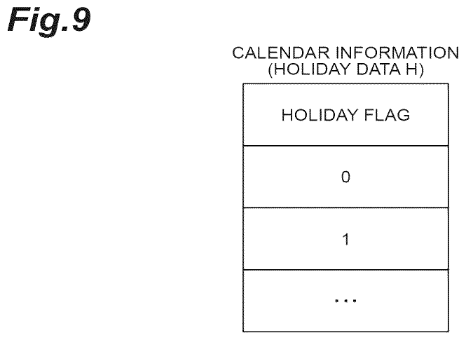

Then, the prediction unit 12 acquires holiday data H from the storage unit 11 (step S5). FIG. 9 is a diagram showing an example of a table of holiday data. In the example of the table of the holiday data H shown in FIG. 9, the holiday data H is shown by a value expressed in 1 bit (in this example, “0” or “1”). Hereinafter, the time data tₙ, the day-of-the-week data Wₙ, and the holiday data H described above will be collectively referred to as “calendar information”.

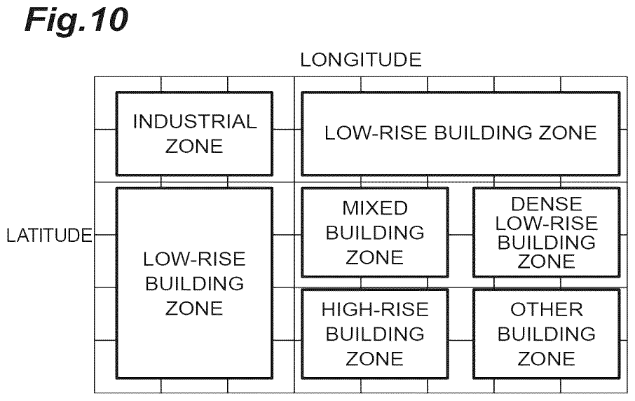

Then, the prediction unit 12 acquires people flow data P from the storage unit 11 (step S6). The people flow data P is data indicating changes in population over time. The power adjustment device 1 may acquire the people flow data P in advance from the external database 20 (for example, a database of a government agency or company that holds the people flow data P), and the storage unit 11 may store the acquired people flow data P. In the present embodiment, as shown in FIG. 10, an area to which power is supplied by the power system 6 is divided into a plurality of zones, and the people flow data P is acquired for each zone. In the example shown in FIG. 10, the area is divided into an “industrial zone” where factories are located, a “low-rise building zone” where low-rise buildings are located, a “mixed building zone” where factories, low-rise buildings, and high-rise buildings are located together, a “dense low-rise building zone” where low-rise buildings are densely located, a “high-rise building zone” where high-rise buildings are located, and an “other building zone” where other buildings are located. Each zone may be divided based on latitude and longitude.

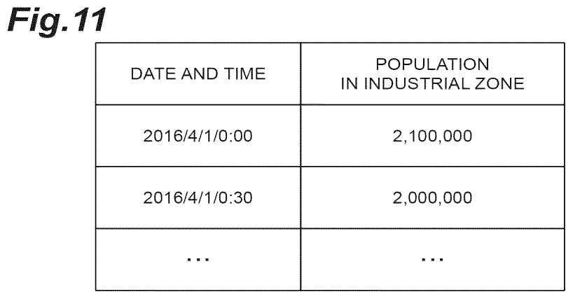

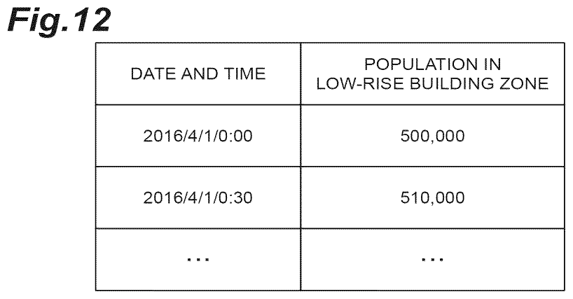

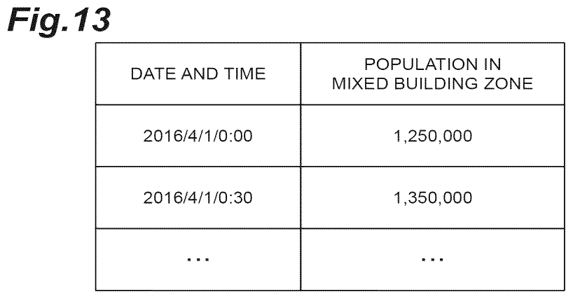

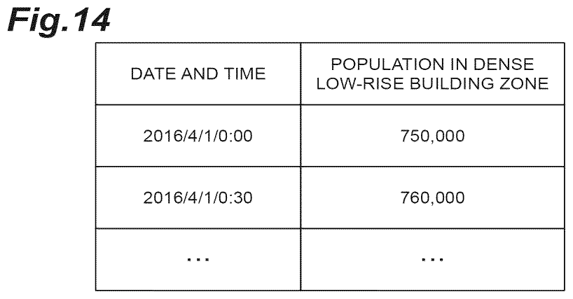

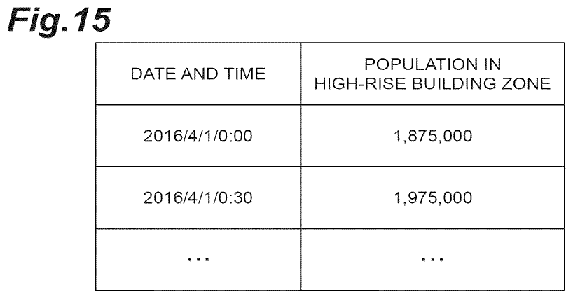

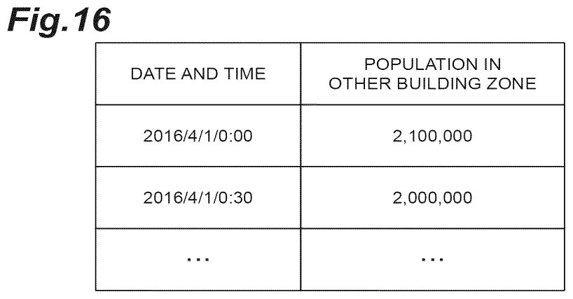

FIG. 11 is a diagram showing an example of a table of people flow data in the industrial zone. FIG. 12 is a diagram showing an example of a table of people flow data in the low-rise building zone. FIG. 13 is a diagram showing an example of a table of people flow data in the mixed building zone. FIG. 14 is a diagram showing an example of a table of people flow data in the dense low-rise building zone. FIG. 15 is a diagram showing an example of a table of people flow data in the high-rise building zone. FIG. 16 is a diagram showing an example of a table of people flow data in the other building zone. In each of the table examples shown in FIGS. 11 to 16, date and time are associated with the population at that date and time. That is, FIGS. 11 to 16 show the population of each zone over time.

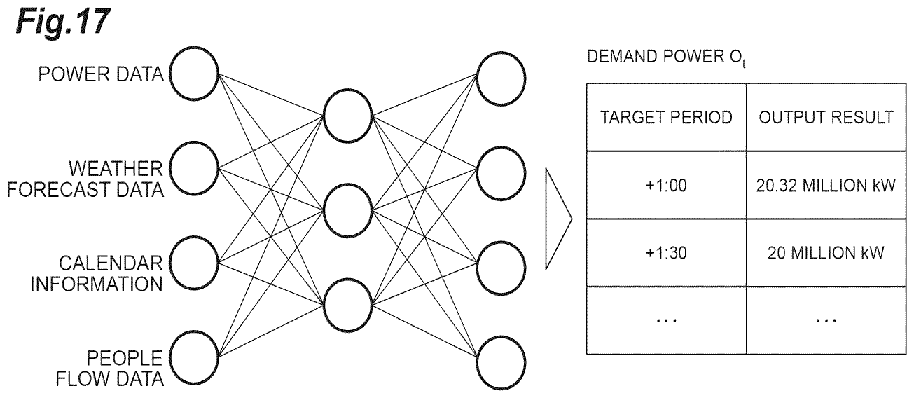

Then, the prediction unit 12 predicts demand power Oₜ for the future target period based on the various kinds of data acquired in steps S1 to S6 (step S7). The prediction unit 12 may use a neural network to predict the demand power Oₜ. For example, the prediction unit 12 may predict the demand power Oₜ using a neural network model that outputs the demand power Oₜ when power data, weather forecast data, calendar information, and people flow data are input as shown in FIG. 17. In the example shown in FIG. 17, the demand power Oₜ is predicted in units of 30 minutes, the demand power Oₜ for the next 30 minutes from one hour after is predicted to be 20.32 million kW, and the demand power Oₜ for the next 30 minutes from one hour and 30 minutes after is predicted to be 20 million kW. The method of predicting the demand power Oₜ is not limited. The prediction unit 12 may predict the demand power Oₜ using other prediction models, such as a state transition model.

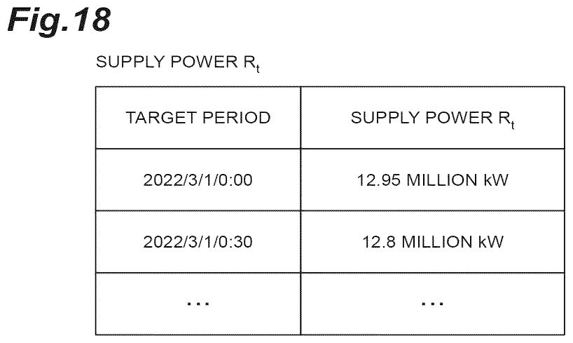

Then, the prediction unit 12 acquires data of supply power Rₜ for the future target period from the storage unit 11 (step S8). The supply power Rₜ is planned in advance by, for example, a power supplier, and is made public. The power adjustment device 1 may acquire the data of the supply power Rₜ in advance from the external database 20 (for example, a database of a power supplier) or the like, and the storage unit 11 may store the acquired data of the supply power Rₜ. FIG. 18 is a diagram showing an example of a table of supply power data. In the example of the table of the data of the supply power Rₜ shown in FIG. 18, the target period and the planned supply power Rₜ are associated with each other. In the example shown in FIG. 18, the supply power Rₜ for 30 minutes from 0:00 on Mar. 1, 2022, is planned to be 12.95 million kW, and the supply power Rₜ for 30 minutes from 0:30 on the same day is planned to be 12.8 million kW.

Then, the prediction unit 12 predicts the power supply and demand balance for the future target period, and determines whether or not an abnormality in the supply and demand balance will occur (step S9). In the embodiment, the prediction unit 12 determines that an abnormality in the supply and demand balance will occur when the demand power Oₜ predicted in step S7 is greater than an upper limit value θ₁ (when Oₜ>θ₁) or smaller than a lower limit value θ₂ (when Oₜ<θ₂).

The upper limit value θ₁ is, for example, a value obtained by multiplying the supply power Rₜ acquired in step S8 by a coefficient α. The coefficient α is, for example, a number greater than 1. The case where the demand power Oₜ is greater than the upper limit value θ₁ corresponds to a case where overdemand for power occurs. The lower limit value θ₂ is, for example, a value obtained by multiplying the supply power Rₜ acquired in step S8 by a coefficient β. The coefficient β is, for example, a number smaller than 1. The case where the demand power Oₜ is smaller than the lower limit value θ₂ corresponds to a case where the oversupply of power occurs. The value of the supply power R₁ used to calculate the upper limit value θ₁ and the lower limit value θ₂ may be the maximum value of the supply power Rₜ on the day to which the target period belongs. For example, when the target period is 30 minutes starting at 0:00 on Mar. 1, 2022, the value of the supply power Rₜ used to calculate the upper limit value θ₁ and the lower limit value θ₂ may be the maximum value of the supply power Rₜ on Mar. 1, 2022. In addition, the value of the supply power Rₜ used to calculate the upper limit value θ₁ and the lower limit value θ₂ may be the value of the supply power Rₜ for the corresponding target period.

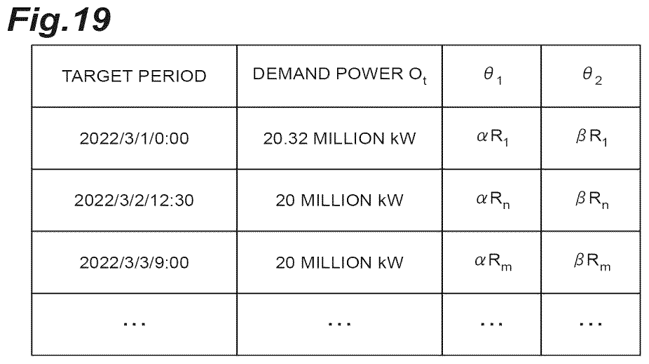

FIG. 19 is an example of a table showing demand power, an upper limit value, and a lower limit value. In the table example of FIG. 19, the target period, the demand power Oₜ for the target period, the upper limit value θ₁, and the lower limit value θ₂ are associated with each other. In the example shown in FIG. 19, the demand power Oₜ in the target period starting from 0:00 on Mar. 1, 2022, is 20.32 million kW, the upper limit value θ₁ is αR₁, and the lower limit value θ₂ is βR₁. R₁ is the maximum value of the supply power Rₜ on Mar. 1, 2022. When the demand power Oₜ “20.32 million kW” is greater than the upper limit value θ₁ “αR₁”, the prediction unit 12 determines that an abnormality in the supply and demand balance (overdemand for power) will occur in the target period starting at 0:00 on Mar. 1, 2022. When the demand power Oₜ “20.32 million kW” is smaller than the lower limit value θ₂ “βR₁”, the prediction unit 12 determines that an abnormality in the supply and demand balance (oversupply of power) will occur in the target period starting at 0:00 on Mar. 1, 2022.

When overdemand for power is predicted, the prediction unit 12 evaluates the degree of overdemand for power (upward swing of the demand power Oₜ) based on the following Expression (1).

$$\begin{matrix}[ Expression 1 ] & \\ f ( {O}_{t} , {R}_{t} ) = \{ \begin{matrix}{O}_{t} - {R}_{t} if {O}_{t} > {θ}_{1} \\ \begin{matrix}0 & otherwise\end{matrix}\end{matrix} & ( 1 )\end{matrix}$$

f(Oₜ, Rₜ) in Expression (1) is an abnormality value, and indicates the degree of abnormality in the supply and demand balance (here, overdemand for power). As shown in the upper expression of Expression (1), the abnormality value f(Oₜ, Rₜ) when Oₜ>θ₁ is the difference between the demand power Oₜ and the supply power Rₜ. In the case of overdemand, the value obtained by subtracting the supply power Rₜ from the demand power Oₜ is the abnormality value f(Oₜ, Rₜ). As the demand power Oₜ increases and the supply power Rₜ decreases, the abnormality value f(Oₜ, Rₜ) increases and accordingly, the degree of overdemand for power increases. As shown in the lower expression of Expression (1), the abnormality value f(Oₜ, Rₜ) is 0 when Oₜ>θ₁ is not satisfied (when the demand power Oₜ is equal to or smaller than the upper limit value θ₁). The prediction unit 12 functions as an abnormality value calculation unit that calculates an abnormality value.

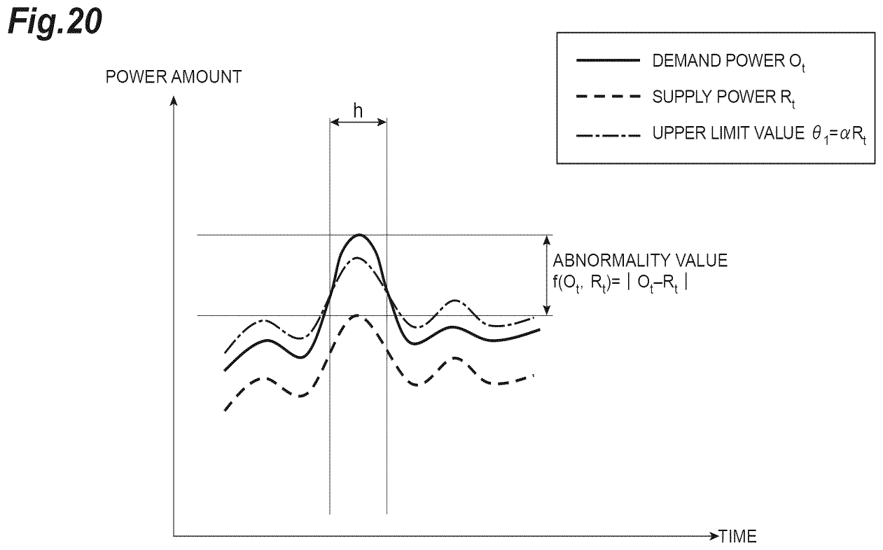

FIG. 20 is a graph showing abnormality values when overdemand for power is predicted. In FIG. 20, the demand power Oₜ is shown by a solid line, the supply power Rₜ is shown by a broken line, and the upper limit value θ₁ is shown by a dashed-dotted line. As shown in FIG. 20, the abnormality value f(Oₜ, Rₜ) in a period in which the demand power Oₜ is greater than the upper limit value θ₁ is a value obtained by subtracting the supply power Rₜ from the demand power Oₜ. The abnormality value f(Oₜ, Rₜ) is equal to the absolute value of the difference between the demand power Oₜ and the supply power Rₜ. The supply and demand balance in the period in which the demand power Oₜ is greater than the upper limit θ₁ is adjusted by controlling the operation of the target power device. The period in which the supply and demand balance is adjusted by controlling the operation of the target power device is referred to as a “control period h”.

On the other hand, when the oversupply of power is predicted, the prediction unit 12 evaluates the degree of oversupply of power (downward swing of the demand power Oₜ) based on the following Expression (2).

$$\begin{matrix}[ Expression 2 ] & \\ f ( {O}_{t} , {R}_{t} ) = \{ \begin{matrix}{R}_{t} - {O}_{t} if {O}_{t} > {θ}_{2} \\ \begin{matrix}0 & otherwise\end{matrix}\end{matrix} & ( 2 )\end{matrix}$$

f(Oₜ, Rₜ) in Expression (2) is an abnormality value, and indicates the degree of abnormality in the supply and demand balance (here, oversupply of power). As shown in the upper expression of Expression (2), the abnormality value f(Oₜ, Rₜ) when Oₜ<θ₂ is the difference between the demand power Oₜ and the supply power Rₜ. In the case of oversupply, a value obtained by subtracting the demand power Oₜ from the supply power Rₜ is the abnormality value f(Oₜ, Rₜ). As the supply power Rₜ increases and the demand power Oₜ decreases, the abnormality value f(Oₜ, Rₜ) increases and accordingly, the degree of oversupply of power increases. As shown in the lower expression of Expression (2), the abnormality value f(Oₜ, Rₜ) is 0 when Oₜ<θ₂ is not satisfied (when the demand power Oₜ is equal to or greater than the lower limit value θ₂).

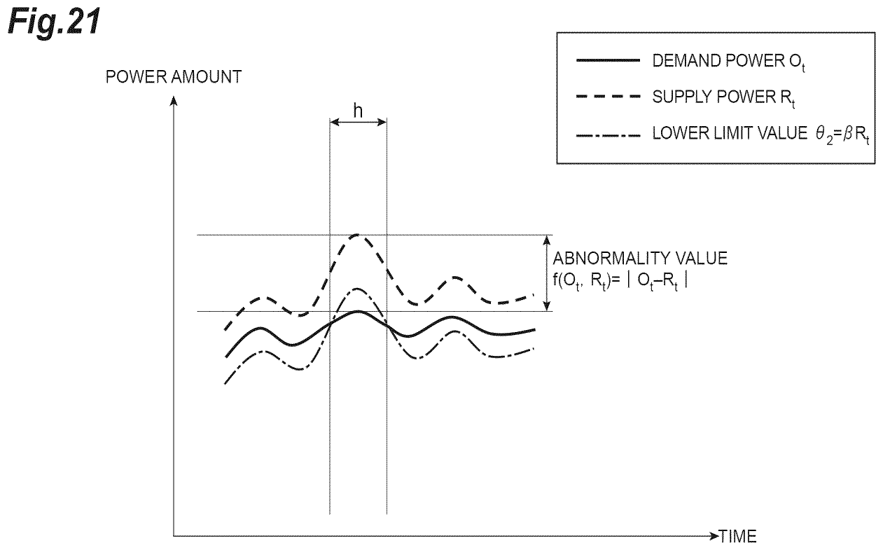

FIG. 21 is a graph showing abnormality values when the oversupply of power is predicted. In FIG. 21, the demand power Oₜ is shown by a solid line, the supply power Rₜ is shown by a broken line, and the lower limit value θ₂ is shown by a dashed-dotted line. As shown in Expression (2), the abnormality value f(Oₜ, Rₜ) in a period in which the demand power Oₜ is smaller than the lower limit value θ₂ is a value obtained by subtracting the demand power Oₜ from the supply power Rₜ. The abnormality value f(Oₜ, Rₜ) is equal to the absolute value of the difference between the demand power Oₜ and the supply power Rₜ. The period in which the demand power Oₜ is smaller than the lower limit value θ₂ corresponds to the control period h.

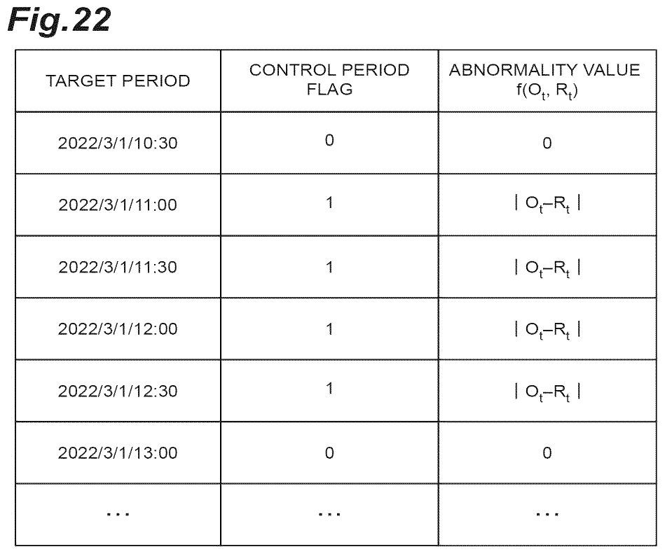

Returning to FIG. 3, the prediction unit 12 calculates the abnormality value f(Oₜ, Rₜ) for a plurality of future target periods by shifting the target period in units of a predetermined time (for example, in units of 30 minutes) to repeatedly perform the processing of step S9. The storage unit 11 stores the abnormality value f(Oₜ, Rₜ) calculated by the prediction unit 12. FIG. 22 is a diagram showing an example of a table of abnormality value data. In the example shown in FIG. 22, the target period is set in units of 30 minutes. In the table example shown in FIG. 22, a target period, a control period flag indicating whether or not the target period is the control period h, and the abnormality value f(Oₜ, Rₜ) are associated with each other. Since there is no need to adjust the supply and demand balance in the target period in which the abnormality value f(Oₜ, Rₜ) is 0, the control period flag is set to “0” indicating that the target period is not the control period h (indicating that no operation control of the target power device is performed). In contrast, since it is necessary to adjust the supply and demand balance in the target period in which the abnormality value f(Oₜ, Rₜ) is not 0, the control period flag is set to “1” indicating that the target period is the control period h (indicating that operation control of the target power device is performed). In the example shown in FIG. 22, two hours from 11:00 on Mar. 1, 2022, is the control period h.

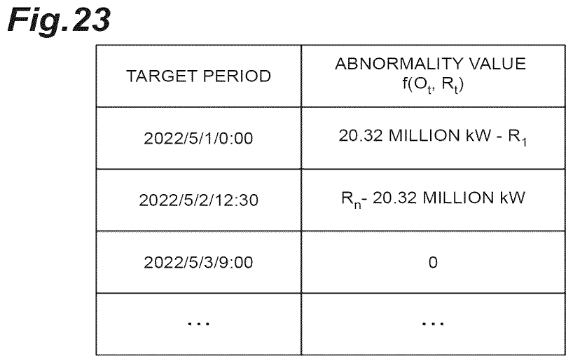

FIG. 23 is a diagram showing another example of the table of abnormality value data. In the example shown in FIG. 23, the target period and the abnormality value f(Oₜ, Rₜ) are associated with each other. In the example shown in FIG. 23, since the demand power Ou for the target period starting at 0:00 on May 1, 2022, is greater than the upper limit value θ₁, the value obtained by subtracting the supply power R₁ from the demand power (20.32 million kW) is recorded as an abnormality value. In the target period starting at 12:30 on May 2, 2022, the demand power Oₜ is smaller than the lower limit value θ₂. Therefore, the value obtained by subtracting the demand power (20.32 million kW) from the supply power Rₙ is recorded as an abnormality value. In the target period starting at 9:00 on May 3, 2022, the demand power Oₜ is not greater than the upper limit value θ₁, and the demand power Oₜ is not smaller than the lower limit value θ₂. Therefore, 0 is recorded as an abnormality value.

When it is predicted that no abnormality in the supply and demand balance will occur in the target period (step S9: No), the setting unit 13 sets a control determination flag F for the target period to “0” (step S10). The control determination flag F is a flag related to the operation control of the target power device by the adjustment unit 14. The control determination flag F is stored in the storage unit 11 so as to be associated with the target period, for example. In the target period in which the control determination flag F is “0”, the adjustment unit 14 does not perform operation control of the target power device. Therefore, the setting unit 13 sets the control determination flag F to “0” for the target period in which it is predicted that no abnormality in the power supply and demand balance will occur.

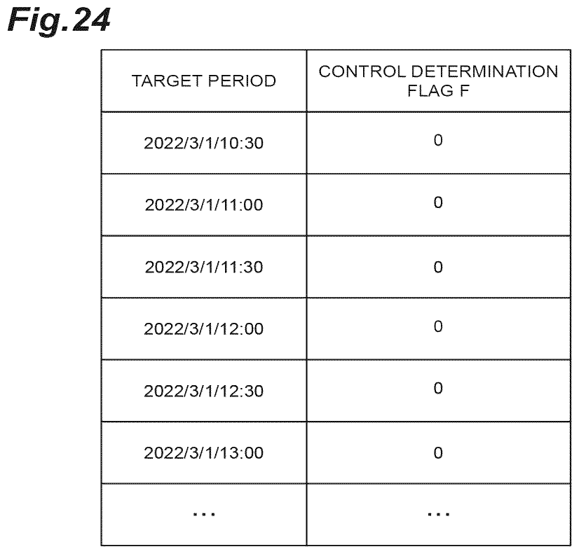

FIG. 24 is a diagram showing an example of the control determination flag. In the example shown in FIG. 24, the target period is set in units of 30 minutes. In the example shown in FIG. 24, the control determination flag F is “O” for the entire target period from 10:30 to 13:30 on Mar. 1, 2022. Therefore, the adjustment unit 14 does not control the operation of the target power device in the period from 10:30 to 13:30 on the same day. The process when the control determination flag F is other than “0” will be described later.

When it is determined that an abnormality in the supply and demand balance will occur in the target period (step S9: Yes), the prediction unit 12 calculates the control period h (step S11). The prediction unit 12 calculates a period from the occurrence of the abnormality in the supply and demand balance to the end as the control period h. For example, in the example shown in FIG. 22, the prediction unit 12 calculates two hours from 11:00 on Mar. 1, 2022, as the control period h.

Then, the prediction unit 12 acquires attributes, discharge output DCHᵢ, charge input CHᵢ, lower limit remaining capacity Sminᵢ, remaining capacity SOCᵢ, and controllability flag f1ᵢ of each storage battery 3 from the storage unit 11 (steps S12 to S17). The attributes of the storage battery 3 are information for identifying the storage battery 3, and may be the name or identification code of the storage battery 3. The discharge output DCHᵢ is the magnitude of the output power when the storage battery 3 is discharged, and indicates an amount that can be discharged to the facility as the discharge characteristic of the storage battery 3. The charge input CHᵢ is the magnitude of the input power when the storage battery 3 is charged, and indicates an amount that can be supplied to the storage battery 3 as the charge characteristic of the storage battery 3. The lower limit remaining capacity Sminᵢ indicates the lower limit value of the remaining capacity SOCᵢ of the storage battery 3. The storage battery 3 can be discharged until the remaining capacity SOCᵢ reaches the lower limit remaining capacity Sminᵢ. The lower limit remaining capacity Sminᵢ may be static data that is manually set in advance. The remaining capacity SOCᵢ is the remaining capacity of the storage battery 3. The controllability flag f1ᵢ is a flag indicating whether or not the storage battery 3 is a storage battery for which operation control related to power is possible. The controllability flag f1ᵢ may be set based on an instruction from the user of the power adjustment device 1, or may be set mechanically according to a predetermined rule. For example, in the case of remaining capacity SOCᵢ>lower limit remaining capacity Sminᵢ or 100%>remaining capacity SOCᵢ, the controllability flag f1ᵢ may be automatically set to “1”. The storage battery 3 whose controllability flag f1ᵢ is “1” corresponds to the target power device whose operation is controlled in the control period h.

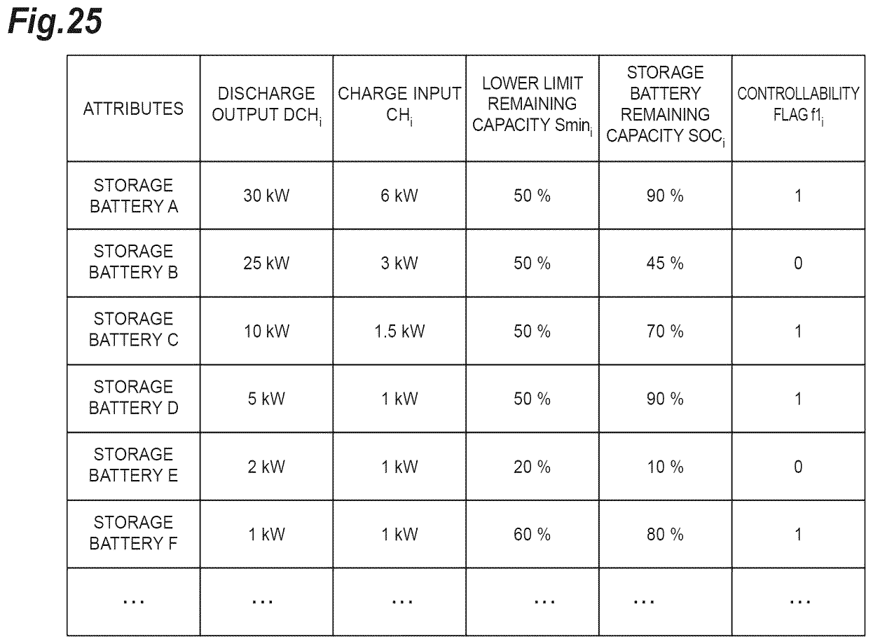

In the present embodiment, data regarding the storage battery 3 including the attributes, the discharge output DCHᵢ, the charge input CHᵢ, the lower limit remaining capacity Sminᵢ, the remaining capacity SOCᵢ, and the controllability flag f1ᵢ of the storage battery 3 is stored in the storage unit 11. FIG. 25 is a diagram showing an example of a table of data regarding a storage battery. In the example of the table of data regarding the storage battery 3 shown in FIG. 25, the attributes, the discharge output DCHᵢ, the charge input CHᵢ, the lower limit remaining capacity Sminᵢ, the remaining capacity SOCᵢ, and the controllability flag f1ᵢ of the storage battery 3 are associated with each other. In the table example of FIG. 25, the data of the storage battery 3 is sorted in descending order of the discharge output DCHᵢ. The data of the storage batteries 3 may be sorted in descending order of the charge input CHᵢ.

Subsequent to the processing of step S17 shown in FIG. 3, the process proceeds to step S18 shown in FIG. 4. The prediction unit 12 determines whether or not the demand power Oₜ for the target period in which an abnormality in the supply and demand balance is predicted to occur is greater than the upper limit value θ₁ (step S18).

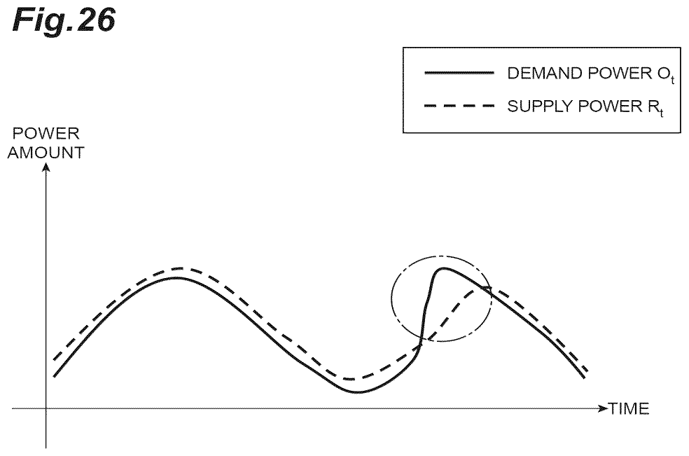

When the demand power Oₜ is greater than the upper limit value θ₁ (step S18: Yes), the setting unit 13 sets the control determination flag F for the target period to “1” (step S19). As described above, when the demand power Oₜ is greater than the upper limit value θ₁, it is predicted that overdemand for power will occur in the target period. FIG. 26 is a graph showing the relationship between demand power and supply power when overdemand for power is predicted. In FIG. 26, the demand power Oₜ is shown by a solid line, and the supply power Rₜ is shown by a broken line. As shown in a portion enclosed by the dash-dotted circle in FIG. 26, there is a risk of overdemand for power in a period in which the demand power Oₜ significantly exceeds the supply power Rₜ.

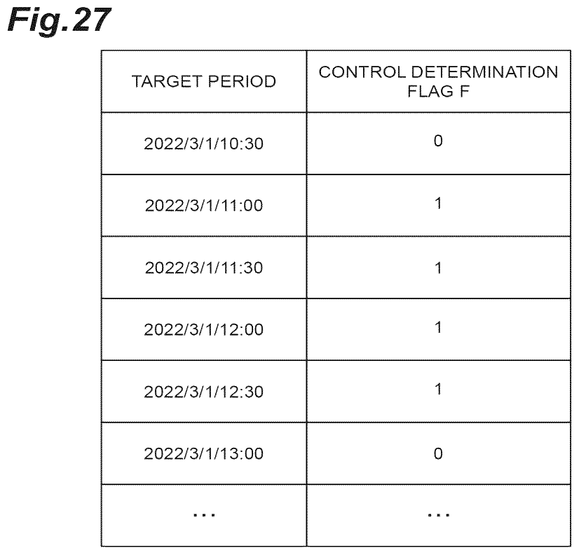

In the target period in which the control determination flag F is “1”, the adjustment unit 14 controls the target power device so that the demand power Oₜ decreases or the supply power Rₜ increases. Therefore, the setting unit 13 sets the control determination flag F to “1” for the target period in which overdemand for power is predicted to occur. FIG. 27 is a diagram showing an example of the control determination flag. In the example shown in FIG. 27, the target period is set in units of 30 minutes. In this example, the control determination flag F for the target period starting at 10:30 on Mar. 1, 2022, and the target period starting at 13:00 on the same day is “0”, and the control determination flag F for the target period from 11:00 to 13:00 on the same day is “1”. Therefore, the adjustment unit 14 does not control the operation of the target power device in the period from 10:30 to 11:00 on the same day and the period from 13:00 to 13:30 on the same day, and controls the target power device so that the demand power Oₜ decreases or the supply power Rₜ increases in the period from 11:00 to 13:00 on the same day.

Then, the prediction unit 12 determines whether the total discharge amount Gd in the control period h in which an abnormality in the supply and demand balance is predicted is equal to or greater than the difference between a demand power amount hOₜ and a supply power amount hRₜ in the control period h (step S20). The “total discharge amount Gd” is the total amount of discharge of the storage battery 3, which is a target power device, in a predetermined period. The “demand power amount hOₜ” is the amount of power that is predicted to be demanded in the power system 6 in a predetermined period. The demand power amount hOₜ may be calculated based on, for example, the product of the demand power Oₜ and time. The “supply power amount hRₜ” is the amount of power that is scheduled to be supplied to the power system 6 in a predetermined period. The amount of supply power hRₜ may be calculated based on, for example, the product of the supply power Rₜ and time.

When calculating the total discharge amount Gd, first, the prediction unit 12 calculates the discharge amount Battᵢ of each storage battery 3 in the control period h. The discharge amount Battᵢ is calculated by the following Expression (3).

$$\begin{matrix}[ Expression 3 ] & \\ {Batt}_{i} = \{ \begin{matrix}\begin{matrix}h \cdot {DCH}_{i} \cdot f {1}_{i} & if SOCi ≫ Smini\end{matrix} \\ \begin{matrix}0 & otherwise\end{matrix}\end{matrix} & ( 3 )\end{matrix}$$

When the remaining capacity SOCᵢ of the storage battery 3 is sufficiently greater than the lower limit remaining capacity Sminᵢ (when SOCᵢ>>Sminᵢ), the discharge amount Battᵢ of the storage battery 3 is calculated by the upper expression of Expression (3). “When the remaining capacity SOCᵢ is sufficiently larger than the lower limit remaining capacity Sminᵢ” refers to a case where the remaining capacity SOCᵢ is so large that the remaining capacity SOCᵢ does not reach the lower limit remaining capacity Sminᵢ even if the storage battery 3 is continuously discharged in the control period h.

When the remaining capacity SOCᵢ of the storage battery 3 is not sufficiently greater than the lower limit remaining capacity Sminᵢ (when the remaining capacity SOCᵢ reaches the lower limit remaining capacity Sminᵢ in the control period h), the discharge amount Battᵢ of the storage battery 3 is calculated by the lower expression of Expression (3). In addition, the discharge amount Battᵢ of the storage battery 3 whose controllability flag f1ᵢ is set to “0” and whose operation cannot be controlled is 0, regardless of the remaining capacity SOCᵢ of the storage battery 3.

The prediction unit 12 calculates the total discharge amount Gd by adding up the discharge amount Battᵢ of each storage battery 3. The prediction unit 12 determines whether the calculated total discharge amount Gd is equal to or greater than the difference between the demand power amount hOₜ and the supply power amount hRₜ in the control period h (hereinafter, referred to as a differential power amount D1) (step S20). In other words, it is determined whether or not the following Expression (4) is satisfied. In this example, the number of storage batteries 3 is assumed to be n.

$$\begin{matrix}[ Expression 4 ] & \\ Gd : {\sum }_{i = 1}^{n} {Batt}_{i} \geq {hO}_{t} - {hR}_{t} & ( 4 )\end{matrix}$$

When it is determined that the total discharge amount Gd is equal to or greater than the differential power amount D1 (step S20: Yes), the setting unit 13 may set the controllability flag f1ᵢ so that the difference between the total discharge amount Gd and the differential power amount D1 is minimized. In other words, the setting unit 13 may reset the controllability flag f1ᵢ so as to satisfy Expression (5).

$$\begin{matrix}[ Expression 5 ] & \\ min ( {\sum }_{i = 1}^{n} {Batt}_{i} ) \geq {hO}_{t} - {hR}_{t} & ( 5 )\end{matrix}$$

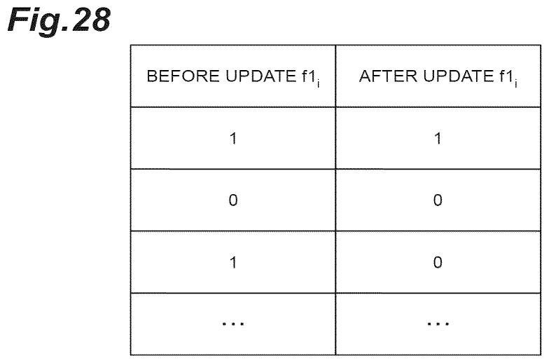

For example, as shown in FIG. 28, the setting unit 13 may reset (update) the controllability flag f1ᵢ of the storage battery 3, which is not used for adjusting the supply and demand balance, from “1” to “0”. Setting the controllability flag f1ᵢ to “0” corresponds to canceling the setting as a target power device. The setting unit 13 may set the controllability flag f1ᵢ based on the discharge output DCHᵢ of the storage battery 3. For example, the setting unit 13 may preferentially set the controllability flag f1ᵢ of the storage battery 3 having the large discharge output DCHᵢ to “1”. That is, the setting unit 13 may set the storage battery 3 having the large discharge output DCHᵢ to be discharged preferentially.

Then, the adjustment unit 14 controls the operation of the target power device (step S21). In this example, the storage battery 3 whose controllability flag f1ᵢ is “1” corresponds to the target power device. The adjustment unit 14 transmits to the control device 2 a control command Aᵢ for discharging the storage battery 3 whose controllability flag f1ᵢ is “1” in the control period h. The amount of power discharged from each storage battery 3 in response to the control command Aᵢ is given by the following Expression (6).

$$\begin{matrix}[ Expression 6 ] & \\ {A}_{i} = \{ \begin{matrix}\begin{matrix}h \cdot {DCH}_{i} \cdot f {1}_{i} & if {SOC}_{i} ≫ {Smin}_{i}\end{matrix} \\ \begin{matrix}\frac{( {SOC}_{i} - {Smin}_{i} ) \cdot h}{100} \cdot {DCH}_{i} \cdot f {1}_{i} & otherwise\end{matrix}\end{matrix} & ( 6 )\end{matrix}$$

Since the control device 2 controls the storage battery 3 based on the control command Aᵢ, the supply and demand balance in the control period h is adjusted to avoid overdemand for power. The timing of the control of the storage battery 3 is determined based on the control determination flag F. For example, the control device 2 controls the storage battery 3 based on the control command Aᵢ in a target period in which the control determination flag F is “1”. Therefore, it is possible to control the operation of the target power device in accordance with the timing when overdemand is predicted to occur. The adjustment unit 14 functions as a plan command creation unit that creates a control plan for the power device to avoid an abnormality in the supply and demand balance. This is the end of the processing by the power adjustment device 1.

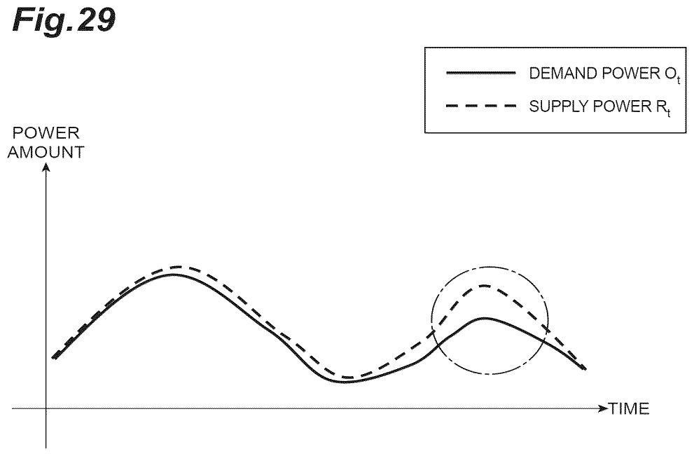

When it is determined that the demand power Oₜ is not greater than the upper limit value θ₁ (step S18: No), the setting unit 13 sets the control determination flag F for the target period to “2” (step S22). It has already been determined in step S9 that an abnormality in the supply and demand balance will occur (corresponding to a case where the demand power Oₜ for the target period is greater than the upper limit 01 or smaller than the lower limit value θ₂). Therefore, the case where it is determined in step S18 that the demand power Oₜ is not greater than the upper limit θ₁ (step S18: No) is a case where the demand power OL for the target period is smaller than the lower limit value θ₂. When the demand power Oₜ is smaller than the lower limit value θ₂, it is predicted that the oversupply of power will occur in the target period. FIG. 29 is a graph showing the relationship between demand power and supply power when the oversupply of power is predicted. In FIG. 29, the demand power Oₜ is shown by a solid line, and the supply power Rₜ is shown by a broken line. As shown in a portion enclosed by the dash-dotted circle in FIG. 29, there is a risk of oversupply of power in a period in which the supply power Rₜ significantly exceeds the demand power Oₜ.

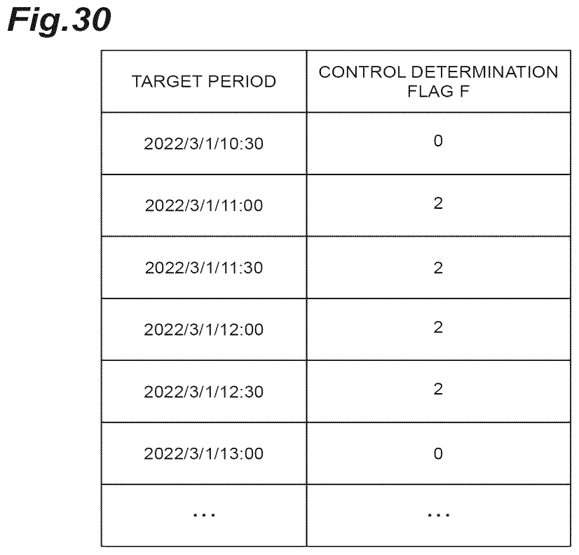

In the target period in which the control determination flag F is “2”, the adjustment unit 14 controls the target power device so that the demand power Oₜ increases or the supply power Rₜ decreases. Therefore, the setting unit 13 sets the control determination flag F to “2” for the target period in which the oversupply of power is predicted to occur. FIG. 30 is a diagram showing an example of the control determination flag. In the example shown in FIG. 30, the target period is set in units of 30 minutes. In this example, the control determination flag F for the target period starting at 10:30 on Mar. 1, 2022, and the target period starting at 13:00 on the same day is “0”, and the control determination flag F for the target period from 11:00 to 13:00 on the same day is “2”. Therefore, the adjustment unit 14 does not control the operation of the target power device in the period from 10:30 to 11:00 on the same day and the period from 13:00 to 13:30 on the same day, and controls the target power device so that the demand power Oₜ increases or the supply power Rₜ decreases in the period from 11:00 to 13:00 on the same day.

Then, the prediction unit 12 determines whether the total charge amount Gc in the control period h is equal to or greater than the difference between the supply power amount hRₜ and the demand power amount hOₜ (step S23). The “total charge amount Gc” is the total amount of charge of the storage battery 3, which is a target power device, in a predetermined period.

When calculating the total charge amount Gc, first, the prediction unit 12 calculates the charge amount Battᵢ of each storage battery 3 in the control period h. The charge amount Battᵢ is calculated by the following Expression (7).

$$\begin{matrix}[ Expression 7 ] & \\ {Batt}_{i} = \{ \begin{matrix}\begin{matrix}h \cdot {CH}_{i} \cdot f {1}_{i} & if {SOC}_{i} ≪ 100\end{matrix} \\ \begin{matrix}\frac{( 100 - {SOC}_{i} ) \cdot h}{100} \cdot {CH}_{i} \cdot f {1}_{i} & otherwise\end{matrix}\end{matrix} & ( 7 )\end{matrix}$$

When the remaining capacity SOCᵢ of the storage battery 3 is sufficiently smaller than 100% (SOCᵢ<<100), the charge amount Battᵢ of the storage battery 3 is calculated by the upper expression of Expression (7). “When the remaining capacity SOC is sufficiently smaller than 100%” refers to a case where the remaining capacity SOCᵢ is so small that the remaining capacity SOCᵢ does not reach 100% even if the storage battery 3 is continuously charged in the control period h.

When the remaining capacity SOCᵢ of the storage battery 3 is not sufficiently smaller than 100% (when the remaining capacity SOCᵢ reaches 100% in the control period h), the charge amount Battᵢ of the storage battery 3 is calculated by the lower expression of Expression (7). In addition, the charge amount Battᵢ of the storage battery 3 whose controllability flag f1ᵢ is “0” and whose operation cannot be controlled is 0, regardless of the remaining capacity SOCᵢ of the storage battery 3.

The prediction unit 12 calculates the total charge amount Gc by adding up the charge amount Battᵢ of each storage battery 3. The prediction unit 12 determines whether the calculated total charge amount Gc is equal to or greater than the difference between the supply power amount hRₜ and the demand power amount hOₜ in the control period h (hereinafter, referred to as a differential power amount D2) (step S23). In other words, it is determined whether or not the following Expression (8) is satisfied.

$$\begin{matrix}[ Expression 8 ] & \\ Gc : {\sum }_{i = 1}^{n} {Batt}_{i} \geq {hR}_{t} - {hO}_{t} & ( 8 )\end{matrix}$$

When it is determined that the total charge amount Gc is equal to or greater than the differential power amount D2 (step S23: Yes), the setting unit 13 may set the controllability flag f1ᵢ so that the difference between the total charge amount Gc and the differential power amount D2 is minimized. In other words, the setting unit 13 may reset the controllability flag f1ᵢ so as to satisfy Expression (9).

$$\begin{matrix}[ Expression 9 ] & \\ min ( {\sum }_{i = 1}^{n} {Batt}_{i} ) \geq {hR}_{t} - {hO}_{t} & ( 9 )\end{matrix}$$

For example, as shown in FIG. 28, the setting unit 13 may reset (update) the controllability flag f1ᵢ of the storage battery 3, which is not used for adjusting the supply and demand balance, from “1” to “0”. The setting unit 13 may set the controllability flag f1ᵢ based on the charge input CHᵢ of the storage battery 3. For example, the setting unit 13 may preferentially set the controllability flag f1ᵢ of the storage battery 3 having the large charge input CHᵢ to “1”. That is, the setting unit 13 may set the storage battery 3 having the large charge input CHᵢ to be charged preferentially.

Then, the adjustment unit 14 controls the operation of the target power device (step S21). In this example, the storage battery 3 whose controllability flag f1ᵢ is “1” corresponds to the target power device. The adjustment unit 14 transmits to the control device 2 a control command Bᵢ for charging the storage battery 3 whose controllability flag f1ᵢ is “1” in the control period h. The amount of power charged to each storage battery 3 in response to the control command Bᵢ is given by the following Expression (10).

$$\begin{matrix}[ Expression 10 ] & \\ {B}_{i} = \{ \begin{matrix}\begin{matrix}h \cdot {CH}_{i} \cdot f {1}_{i} & if {SOC}_{i} ≪ 100\end{matrix} \\ \begin{matrix}\frac{( 100 - {SOC}_{i} ) \cdot h}{100} \cdot {CH}_{i} \cdot f {1}_{i} & otherwise\end{matrix}\end{matrix} & ( 10 )\end{matrix}$$

Since the control device 2 controls the storage battery 3 based on the control command Bᵢ, the supply and demand balance in the control period h is adjusted to avoid the oversupply of power. The control device 2 controls the storage battery 3 based on the control command Bᵢ in a target period in which the control determination flag F is “2”, for example. Therefore, it is possible to control the operation of the target power device in accordance with the timing when oversupply is predicted to occur. This is the end of the processing by the power adjustment device 1.

When it is determined that the total discharge amount Gd is not equal to or greater than the differential power amount D1 (step S20: No), the prediction unit 12 acquires the attributes, output Mᵢ, controllability flag f2ᵢ, and operation flag f3ᵢ of each load 4 from the storage unit 11 (steps S24 to S27). The case where it is determined that the total discharge amount Gd is not equal to or greater than the differential power amount D1 refers to a case where the differential power amount D1 cannot be compensated for just by discharging the storage battery 3 and accordingly, the abnormality in the supply and demand balance (overdemand for power) cannot be resolved, which corresponds to a case where the following Expression (11) is satisfied.

$$\begin{matrix}[ Expression 11 ] & \\ Gd : {\sum }_{i = 1}^{n} {Batt}_{i} \geq {hO}_{t} - {hR}_{t} & ( 11 )\end{matrix}$$

The attributes of the load 4 are information for identifying the load 4, and may be the name or identification code of the load 4. The output Mᵢ is the power consumed while the load 4 is in operation, and is the maximum amount of output that can be generated by controlling the operation of the load 4. The larger the output Mᵢ of the load 4, the larger the amount of power consumed during operation. The controllability flag f2ᵢ is a flag indicating whether or not the load 4 is a load for which operation control related to power is possible. The controllability flag f2ᵢ may be set based on an instruction from the user of the power adjustment device 1, or may be set mechanically according to a predetermined rule. The load 4 whose controllability flag f2ᵢ is “1” is a target power device whose operation is controlled in the control period h. The operation flag f3ᵢ is a flag indicating the operating state of the load 4, and may be, for example, a flag indicating ON/OFF of a power source for the load 4. The operation flag f3ᵢ may be set based on an operation schedule for the control timing of the load 4.

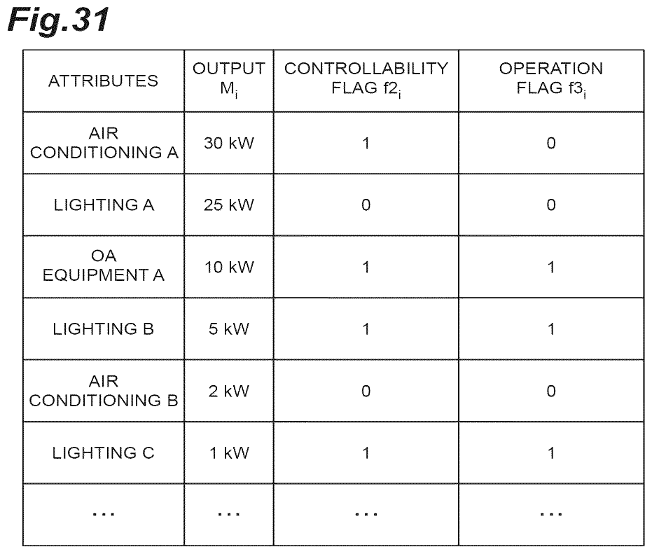

In the embodiment, data regarding the load 4 including the attributes, the output Mᵢ, the controllability flag f2ᵢ, and the operation flag f3ᵢ of the load 4 is stored in the storage unit 11. FIG. 31 is a diagram showing an example of a table of data regarding a load. In the example of the table of data regarding the load 4 shown in FIG. 31, the attributes, the output Mᵢ, the controllability flag f2ᵢ, and the operation flag f3ᵢ of the load 4 are associated with each other. In the table example of FIG. 31, the data of load 4 is sorted in descending order of the output Mᵢ.

Then, the prediction unit 12 determines whether or not the abnormality in the supply and demand balance can be resolved by controlling the operations of the storage battery 3 and the load 4 set as target power devices (step S28). Specifically, the prediction unit 12 determines whether or not overdemand for power can be resolved by deactivating the load 4 set as a target power device in addition to discharging the storage battery 3 set as a target power device.

When making this determination, first, the prediction unit 12 calculates a demand power amount that can be reduced in the control period h by controlling the operation of the load 4. The demand power amount that can be reduced corresponds to a demand power amount that can be reduced by deactivating the load 4 of the target power device, and is calculated by the following Expression (12). Expression (12) shows a total demand power amount that can be reduced in each load 4. In this example, the number of loads 4 is assumed to be L. Since it is not possible to perform operation control to deactivate the load 4 whose controllability flag f2ᵢ is “0”, the demand power amount that can be reduced is 0. In addition, since the load 4 whose operation flag f3ᵢ is “0” has already been deactivated, the demand power amount that can be reduced when performing control for deactivation is 0.

$$\begin{matrix}[ Expression 12 ] & \\ {\sum }_{m = 1}^{L} {M}_{i} \cdot h \cdot f {2}_{i} \cdot f {3}_{i} & ( 12 )\end{matrix}$$

The prediction unit 12 calculates an adjustment power amount, which can be adjusted by controlling the operations of the storage battery 3 and the load 4, by adding the total discharge amount Gd (left side of Expression (11)) and the demand power amount that can be reduced by controlling the operation of the load 4 (Expression (12)). The adjustment power amount corresponds to the left side of the following Expression (13). The prediction unit 12 determines whether or not the calculated adjustment power amount is equal to or greater than the differential power amount D1 (whether or not Expression (13) is satisfied), thereby determining whether or not the abnormality in the supply and demand balance can be resolved by controlling the operations of the storage battery 3 and the load 4 set as target power devices (step S28).

$$\begin{matrix}[ Expression 13 ] & \\ {\sum }_{m = 1}^{L} {M}_{i} \cdot h \cdot f {2}_{i} \cdot f {3}_{i} + {\sum }_{i = 1}^{n} {Batt}_{i} \geq {hO}_{t} - {hR}_{t} & ( 13 )\end{matrix}$$

When it is determined that the abnormality in the supply and demand balance can be resolved (step S28: Yes), the setting unit 13 may set the controllability flags f1ᵢ and f2ᵢ so that the difference between the adjustment power amount and the differential power amount D1 is minimized. In other words, the setting unit 13 may reset the controllability flag f2ᵢ so as to satisfy Expression (14).

$$\begin{matrix}[ Expression 14 ] & \\ min ( {\sum }_{m = 1}^{L} {M}_{i} \cdot h \cdot f {2}_{i} \cdot f {3}_{i} ) \geq {hO}_{t} - {hR}_{t} - {\sum }_{i = 1}^{n} {Batt}_{i} & ( 14 )\end{matrix}$$

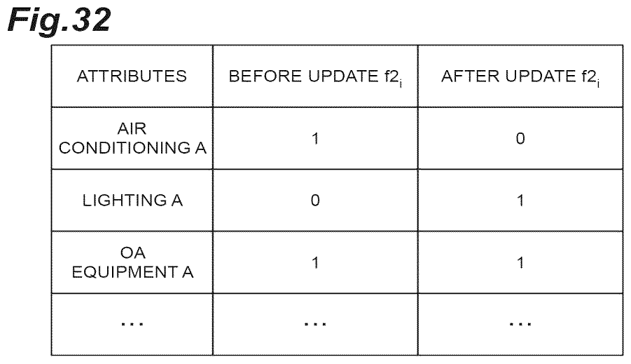

For example, as shown in FIG. 32, the setting unit 13 may reset (update) the controllability flag f2ᵢ of the load 4, which is not used for adjusting the supply and demand balance, from “1” to “0”, and may reset (update) the controllability flag f2ᵢ of the load 4, which is used for adjusting the supply and demand balance, from “0” to “1”. Setting the controllability flag f2; to “0” corresponds to canceling the setting as a target power device, and setting the controllability flag f2ᵢ to “1” corresponds to setting as a target power device. The setting unit 13 may set the controllability flag f2ᵢ based on the output Mᵢ of the load 4. For example, the setting unit 13 may preferentially set the controllability flag f2ᵢ of the load 4 having the large output Mᵢ to “1”. That is, the setting unit 13 may set the load 4 having the large output Mᵢ to be deactivated preferentially.

In addition, the setting unit 13 may set the controllability flag f2ᵢ based on the operating state (operation flag f3ᵢ) of the load 4. For example, even if the load 4 that is planned to be deactivated in the target period (load 4 whose operation flag f3ᵢ is “0”) is newly set as a target power device and operation control is performed to deactivate the load 4 in the target period, it is not possible to reduce the demand power. Therefore, the setting unit 13 may set the load 4 that is planned to be activated in the target period (load 4 whose operation flag f3ᵢ is “1”) as a target power device (may change the controllability flag f2ᵢ from “0” to “1”).

Then, the adjustment unit 14 controls the operation of the target power device (step S21). In this example, the storage battery 3 whose controllability flag f1ᵢ is “1” and the load 4 whose controllability flag f2; is “1” correspond to target power devices. The adjustment unit 14 transmits to the control device 2 a control command Aᵢ for discharging the storage battery 3 whose controllability flag f1ᵢ is “1” in the control period h and a control command Cᵢ for deactivating the load 4 whose controllability flag f2ᵢ is “1” in the control period h. The amount of power discharged from each storage battery 3 in response to the control command Aᵢ is given by the above-described Expression (6). The demand power amount that is reduced in each load 4 in response to the control command Cᵢ is given by the following Expression (15).

$$\begin{matrix}[ Expression 15 ] & \\ {C}_{i} = {M}_{i} \cdot h \cdot f {2}_{i} \cdot f {3}_{i} & ( 15 )\end{matrix}$$

Since the control device 2 controls the storage battery 3 and the load 4 based on the control commands Aᵢ and Cᵢ, the supply and demand balance in the control period h is adjusted to avoid overdemand for power. The timing of the control of the storage battery 3 and the load 4 is determined based on the control determination flag F. The control device 2 controls the storage battery 3 based on the control commands Aᵢ and Cᵢ in a period in which the control determination flag F is “1”, for example. Therefore, it is possible to control the operation of the target power device in accordance with the timing when overdemand is predicted to occur. This is the end of the processing by the power adjustment device 1. In addition, although the supply and demand balance is adjusted by deactivating the load 4 in operation in this example, the supply and demand balance may also be adjusted by reducing the output of the load 4 in operation. That is, the operation control for the load 4 set as a target power device may be a control to reduce the output.

When it is determined that the abnormality in the supply and demand balance cannot be resolved by controlling the operations of the storage battery 3 and the load 4 set as target power devices (step S28: No), the setting unit 13 resets the controllability flags f1ᵢ and f2ᵢ. Resetting the controllability flags f1ᵢ and f2ᵢ corresponds to resetting the target power devices. That is, the setting unit 13 changes the storage battery 3 and the load 4 set as target power devices by resetting the controllability flags f1ᵢ and f2ᵢ.

The setting unit 13 resets the controllability flags f1ᵢ and f2ᵢ so as to satisfy Expression (13), for example. The setting unit 13 may newly set the storage battery 3 and the load 4, which are not set as target power devices, as target power devices. The setting unit 13 may set the controllability flag f1ᵢ based on the discharge output DCHᵢ of the storage battery 3. For example, the setting unit 13 may preferentially set the controllability flag f1ᵢ of the storage battery 3 having the large discharge output DCHᵢ to “1”. The setting unit 13 may set the controllability flag f2ᵢ based on the output Mᵢ of the load 4. For example, the setting unit 13 may preferentially set the controllability flag f2ᵢ of the load 4 having the large output Mᵢ to “1”.

In addition, the setting unit 13 may reset the controllability flag f2ᵢ based on the operating state (operation flag f3ᵢ) of the load 4. For example, the setting unit 13 may set the load 4 planned to be activated in the target period (load 4 whose operation flag f3ᵢ is “1”) as a target power device (may change the controllability flag f2ᵢ from “0” to “1”). The setting unit 13 may reset the controllability flags f1ᵢ and f2ᵢ based on an instruction from the user of the power adjustment device 1.

Circled B in FIG. 4 corresponds to circled B in FIG. 3, and the process returns to step S17 shown in FIG. 3 when the resetting of the controllability flags f1ᵢ and f2ᵢ by the setting unit 13 (step S29) ends.

When it is determined that the total charge amount Gc is not equal to or greater than the differential power amount D2 (step S23: No), the prediction unit 12 acquires the attributes, the output Mᵢ, the controllability flag f2ᵢ, and the operation flag f3ᵢ of each load 4 from the storage unit 11 (steps S24 to S27). The case where it is determined that the total charge amount Gc is not equal to or greater than the differential power amount D2 refers to a case where the differential power amount D2 cannot be compensated for just by charging the storage batteries 3 and accordingly, the abnormality in the supply and demand balance (oversupply of power) cannot be resolved, which corresponds to a case where the following Expression (16) is satisfied.

$$\begin{matrix}[ Expression 16 ] & \\ Gc : {\sum }_{i = 1}^{n} {Batt}_{i} < {hR}_{t} - {hO}_{t} & ( 16 )\end{matrix}$$

Then, the prediction unit 12 determines whether or not the abnormality in the supply and demand balance can be resolved by controlling the operations of the storage battery 3 and the load 4 set as target power devices (step S28). Specifically, the prediction unit 12 determines whether or not the oversupply of power can be resolved by activating the load 4 set as a target power device in addition to charging the storage battery 3 set as a target power device.

When making this determination, first, the prediction unit 12 calculates a demand power amount that can be increased in the control period h by controlling the operation of the load 4. The demand power amount that can be increased corresponds to a demand power amount that can be increased by activating the load 4 of the target power device, and is calculated by the following Expression (17). Expression (17) shows a total demand power amount that can be increased in each load 4. In this example, the number of loads 4 is assumed to be L. Since it is not possible to perform operation control to activate the load 4 whose controllability flag f2ᵢ is “0”, the demand power amount that can be reduced is 0. In addition, since the load 4 whose operation flag f3ᵢ is “1” is already in operation, the demand power amount that can be increased when performing control for activation is 0.

$$\begin{matrix}[ Expression 17 ] & \\ {\sum }_{m = 1}^{L} {M}_{i} \cdot h \cdot f {2}_{i} \cdot ∼ f {3}_{i} & ( 17 )\end{matrix}$$

The prediction unit 12 calculates an adjustment power amount, which can be adjusted by controlling the operations of the storage battery 3 and the load 4, by adding the total charge amount Gc (left side of Expression (16)) and the demand power amount that can be increased by controlling the operation of the load 4 (Expression (17)). The adjustment power amount corresponds to the left side of the following Expression (18). The prediction unit 12 determines whether or not the calculated adjustment power amount is equal to or greater than the differential power amount D2 (whether or not Expression (18) is satisfied), thereby determining whether or not the abnormality in the supply and demand balance can be resolved by controlling the operations of the storage battery 3 and the load 4 set as target power devices (step S28).

$$\begin{matrix}[ Expression 18 ] & \\ {\sum }_{m = 1}^{L} {M}_{i} \cdot h \cdot f {2}_{i} \cdot ∼ f {3}_{i} + {\sum }_{i = 1}^{n} {Batt}_{i} \geq {hR}_{t} - {hO}_{t} & ( 18 )\end{matrix}$$

When it is determined that the abnormality in the supply and demand balance can be resolved (step S28: Yes), the setting unit 13 may set the controllability flags f1ᵢ and f2ᵢ so that the difference between the adjustment power amount and the differential power amount D2 is minimized. In other words, the setting unit 13 may set the controllability flag f2ᵢ so as to satisfy Expression (19).

$$\begin{matrix}[ Expression 19 ] & \\ min ( {\sum }_{m = 1}^{L} {M}_{i} \cdot h \cdot f {2}_{i} \cdot ∼ f {3}_{i} ) \geq {hR}_{t} - {hO}_{t} - {\sum }_{i = 1}^{n} {Batt}_{i} & ( 19 )\end{matrix}$$

For example, as shown in FIG. 32, the setting unit 13 may reset (update) the controllability flag f2ᵢ of the load 4, which is not used for adjusting the supply and demand balance, from “1” to “0”, and may reset (update) the controllability flag f2ᵢ of the load 4, which is used for adjusting the supply and demand balance, from “0” to “1”. The setting unit 13 may set the controllability flag f2ᵢ based on the output Mᵢ of the load 4. For example, the setting unit 13 may preferentially set the controllability flag f2ᵢ of the load 4 having the large output Mᵢ to “1”. That is, the setting unit 13 may set the load 4 having the large output Mᵢ to be activated preferentially.

In addition, the setting unit 13 may set the controllability flag f2ᵢ based on the operating state (operation flag f3ᵢ) of the load 4. For example, even if the load 4 that is planned to be activated in the target period (load 4 whose operation flag f3ᵢ is “1”) is newly set as a target power device and operation control is performed to activate the load 4 in the target period, it is not possible to increase the demand power. Therefore, the setting unit 13 may set the load 4 that is planned to be deactivated in the target period (load 4 whose operation flag f3ᵢ is “0”) as a target power device (may change the controllability flag f2ᵢ from “0” to “1”).

Then, the adjustment unit 14 controls the operation of the target power device (step S21). In this example, the storage battery 3 whose controllability flag f1ᵢ is “1” and the load 4 whose controllability flag f2ᵢ is “1” correspond to target power devices. The adjustment unit 14 transmits to the control device 2 the control command Bᵢ for charging the storage battery 3 whose controllability flag f1ᵢ is “1” in the control period h and the control command Dᵢ for activating the load 4 whose controllability flag f2ᵢ is “1” in the control period h. The amount of power charged to each storage battery 3 in response to the control command Bᵢ is given by the above-described Expression (10). The demand power amount that is increased in each load 4 in response to the control command Dᵢ is given by the following Expression (20).

$$\begin{matrix}[ Expression 20 ] & \\ {D}_{i} = {M}_{i} \cdot h \cdot f {2}_{i} \cdot ∼ f {3}_{i} & ( 20 )\end{matrix}$$

Since the control device 2 controls the storage battery 3 and the load 4 based on the control commands Bᵢ and Dᵢ, the supply and demand balance in the control period h is adjusted to avoid the oversupply of power. The control device 2 controls the storage battery 3 based on the control commands Bᵢ and Dᵢ in a period in which the control determination flag F is “2”, for example. Therefore, it is possible to control the operation of the target power device in accordance with the timing when oversupply is predicted to occur. This is the end of the processing by the power adjustment device 1. In addition, although the supply and demand balance is adjusted by activating the load 4 that is not in operation in this example, the supply and demand balance may also be adjusted by increasing the output of the load 4 in operation. That is, the operation control for the load 4 set as a target power device may be control to increase the output.

When it is determined that the abnormality in the supply and demand balance cannot be resolved by controlling the operations of the storage battery 3 and the load 4 set as target power devices (step S28: No), the setting unit 13 resets the controllability flags f1ᵢ and f2ᵢ. Resetting the controllability flags f1ᵢ and f2; corresponds to resetting the target power devices. That is, the setting unit 13 changes the storage battery 3 and the load 4 set as target power devices by resetting the controllability flags f1ᵢ and f2ᵢ.

The setting unit 13 resets the controllability flags f1ᵢ and f2ᵢ so as to satisfy Expression (18), for example. The setting unit 13 may newly set the storage battery 3 and the load 4, which are not set as target power devices, as target power devices. The setting unit 13 may set the controllability flag f1ᵢ based on the charge input CHᵢ of the storage battery 3. For example, the setting unit 13 may preferentially set the controllability flag f1ᵢ of the storage battery 3 having the large charge input CHᵢ to “1”. The setting unit 13 may set the controllability flag f2ᵢ based on the output Mᵢ of the load 4. For example, the setting unit 13 may preferentially set the controllability flag f2; of the load 4 having the large output Mᵢ to “1”. The setting unit 13 may reset the controllability flags f1ᵢ and f2ᵢ based on an instruction from the user of the power adjustment device 1.

In addition, the setting unit 13 may reset the controllability flag f2ᵢ based on the operating state (operation flag f3ᵢ) of the load 4. For example, the setting unit 13 may set the load 4 that is planned to be deactivated in the target period (load 4 whose operation flag f3ᵢ is “0”) as a target power device (may change the controllability flag f2ᵢ from “0” to “1”). When the resetting of the controllability flags f1ᵢ and f2ᵢ by the setting unit 13 (step S29) ends, the process returns to step S17 shown in FIG. 3.

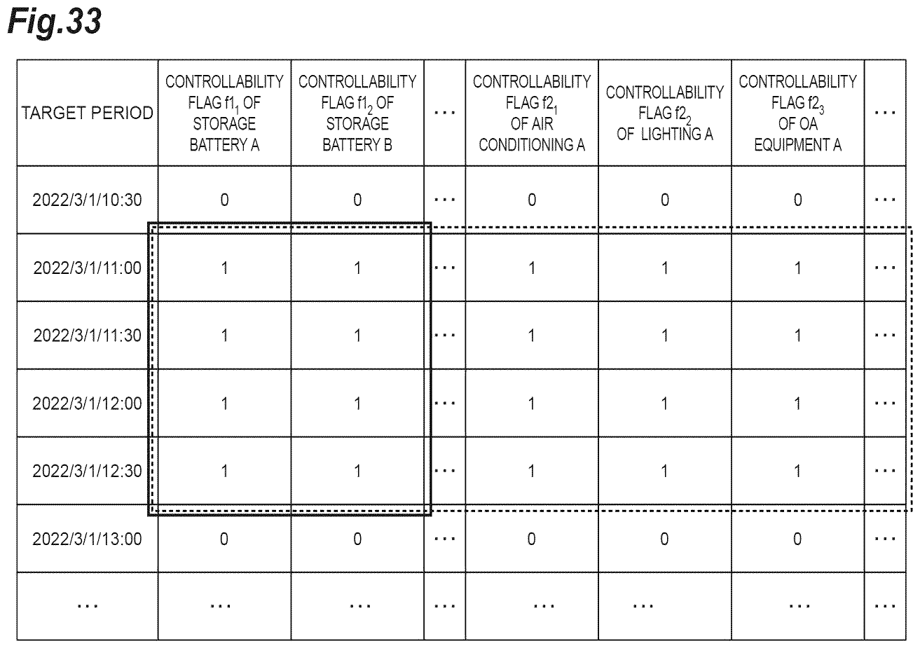

FIG. 33 is a diagram showing an example of the controllability flags of the storage battery and the load. When the control command Aᵢ or the control command Bᵢ is transmitted to the control device 2 by the adjustment unit 14, the operation of the storage battery 3 whose controllability flag f1ᵢ is “1” (set as a target power device) in the control period h is controlled. In the example shown in FIG. 33, in the control period h (two hours from 11:00 on Mar. 1, 2022, which is a target period corresponding to a portion surrounded by the solid line), the operations of at least storage batteries A and B surrounded by the solid line are controlled.

When the control commands Aᵢ and Cᵢ or the control commands Bᵢ and Dᵢ are transmitted to the control device 2 by the adjustment unit 14, the operations of the storage battery 3 and the load 4 whose controllability flags f1ᵢ and f2ᵢ are “1” (set as target power devices) in the control period h are controlled. In the example shown in FIG. 33, in the control period h (two hours from 11:00 on Mar. 1, 2022, which is a target period corresponding to a portion surrounded by the broken line), the operations of at least the storage batteries A and B, air conditioning A, lighting A, and OA equipment A, which are surrounded by the broken line, are controlled.

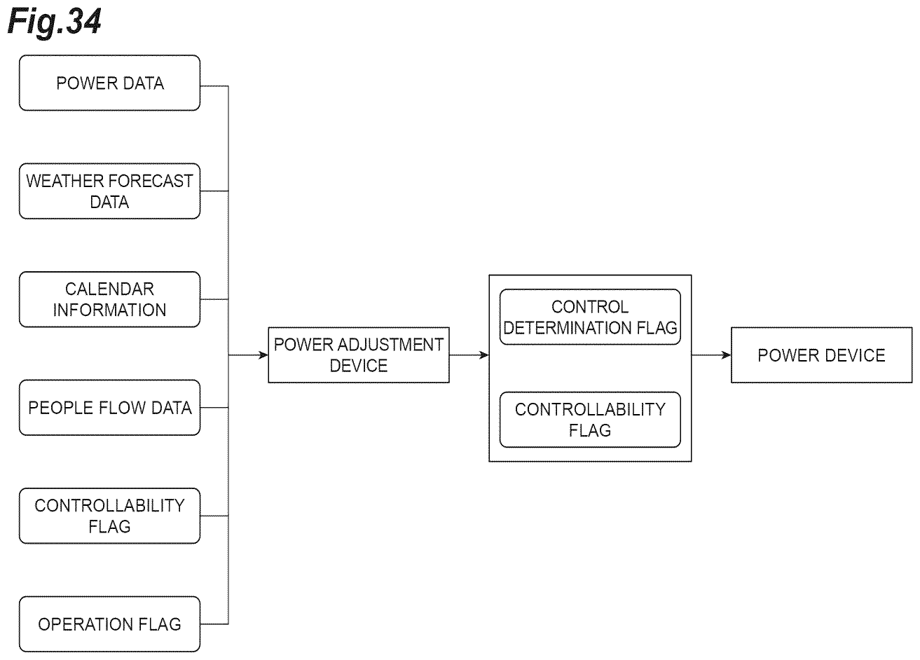

FIG. 34 is a diagram showing input to and output from a power adjustment device. As shown in FIG. 34, the power data Eₜ, weather forecast data, calendar information, the people flow data P, the controllability flags f1ᵢ and f2ᵢ, and the operation flag f3ᵢ are input to the power adjustment device 1. The power adjustment device 1 performs the processes explained in FIGS. 3 and 4 based on the various kinds of input data, and sets (outputs) the control determination flag F and the controllability flags f1ᵢ and f2ᵢ. The operation of the power device is controlled based on the set control determination flag F and controllability flags f1ᵢ and f2ᵢ.

Next, the function and effect of the power adjustment device 1 according to the embodiment will be described.

According to the power adjustment device 1, the setting unit 13 sets at least one of power devices as a target power device based on the predicted supply and demand balance, and the adjustment unit 14 adjusts the supply and demand balance by controlling the operation of the target power device. With this configuration, a target power device whose operation is to be controlled in order to adjust the supply and demand balance can be set based on the predicted power supply and demand balance. Therefore, it is possible to appropriately adjust the power supply and demand balance.

The function and effect of the power adjustment device 1 will be described more specifically together with the technical background. In order to stably supply power, the demand power amount and the supply power amount should always be balanced at the same time. In recent years, there have been concerns about instability in the power supply and demand balance due to excessive demand power (overdemand) caused by increasingly severe weather changes and excessive power generation from renewable energy (oversupply). Under such circumstances, the introduction of mechanisms such as virtual power plants and demand response, which adjust the amount of power consumed by power consumers, is progressing. Within this framework, consumers are required to receive a command to increase their power consumption or a command to reduce their power consumption and respond accurately to the commands. Targets to be controlled when consumers receive such commands include a storage battery installed for backup in the event of a power outage at the facility, or a load such as an air conditioning system or a lighting system that consumes a large amount of power at the facility.

In order to respond appropriately to a request notified from the power supply side as described above, it is necessary to control the power devices whose operations can be controlled at that stage and generate an appropriate amount of power. However, when a command to control the power devices was not given in advance, the request could not be met, and as a result, the supply and demand balance could become unstable.

The power adjustment device 1 performs a wide-area forecast of demand power to specify a period in which the power supply and demand balance may be unstable (an abnormality in the supply and demand balance may occur) while performing a comparison with the expected demand power (planned supply power) on the supply side. The power adjustment device 1 calculates the difference between the demand power and the supply power in the period as an abnormality value. As a method for calculating the abnormality value, a threshold value (upper limit value) for detecting a case where demand power is significantly larger than demand power expected by the power company (planned power supply) and a threshold value (lower limit value) for detecting a case where demand power is significantly smaller than demand power expected by the power company (planned power supply) are created, and any value exceeding the threshold values is regarded as an abnormality value. By transmitting a control command to each power device in advance in response to the occurrence of such an abnormality value, it is possible to cancel out any abnormality values that may have occurred in the period as the total amount of the control. Even when the power adjustment device 1 receives an unexpected control command from an external source such as a power supplier, the power demand side can adjust the control amount, and it is possible to prevent the power supply and demand balance from becoming unstable in advance. Therefore, it is possible to provide a power control system that can be implemented independently on the power consumer side. As a result, the power adjustment device 1 can prevent the power supply and demand balance from becoming unstable by providing a control command to the power device in advance in response to the destabilization of the power supply and demand balance.

In addition, according to the power adjustment device 1, when it is predicted that an abnormality in the supply and demand balance will occur, the setting unit 13 may set the target power device so that the abnormality in the supply and demand balance can be resolved. With this configuration, the abnormality in the supply and demand balance can be resolved by controlling the operation of the target power device.

In addition, according to the power adjustment device 1, the setting unit 13 may set the target power device so that the adjustment power amount that can be adjusted by controlling the operation of the target power device is equal to or greater than the differential power amount, which is the difference between the supply power amount scheduled to be supplied to the power system 6 and the demand power amount predicted to occur in the power system 6. With this configuration, the abnormality in the supply and demand balance can be reliably resolved by controlling the operation of the target power device. In addition, according to the power adjustment device 1, the setting unit 13 may set the target power device so that the difference between the adjustment power amount and the differential power amount is minimized. With this configuration, since it is not necessary to perform operation control for power devices that is not necessary for adjusting the supply and demand balance, the supply and demand balance can be adjusted efficiently. For example, when discharging the storage battery 3 to resolve overdemand for power, it is possible to avoid discharging the storage battery 3 that is not required.

In addition, according to the power adjustment device 1, the setting unit 13 may set the target power device based on at least one of the amount of power charged and discharged in the storage battery 3 and the amount of power consumed by the load 4. With this configuration, it is possible to set the target power device more appropriately. For example, by setting the storage battery 3, which is charged and discharged with a large amount of power, and the load 4, by which a large amount of power is consumed (which has a large output), preferentially as target power devices, it is possible to reduce the number of target power devices whose operations are to be controlled.

In addition, according to the power adjustment device 1, the power system 6 may include one or more storage batteries 3 and one or more loads 4, and the setting unit 13 may set the one or more storage batteries 3 and the one or more loads 4 as target power devices. With this configuration, compared to a case where the power system 6 includes only one of the storage battery 3 and the load 4, the selection of power devices that can be set as target power devices is expanded. Therefore, the supply and demand balance can be adjusted more appropriately.

In addition, according to the power adjustment device 1, the setting unit 13 may determine whether or not to set the load 4 as a target power device based on the operating state of the load 4. With this configuration, the target power device can be appropriately set in consideration of the operating state of the load 4.

In addition, according to the power adjustment device 1, the setting unit 13 may set the target power device based on an instruction from the user of the power adjustment device 1. With this configuration, for example, it is possible not only to set the target power device mechanically based on a predetermined standard but also to set the target power device more flexibly based on an instruction from the user of the power adjustment device 1.

For example, the power system 6 may include only one of the storage battery 3 and the load 4. The number of storage batteries 3 included in the power system 6 is not limited, and may be one. The number of loads 4 included in the power system 6 is not limited, and may be one.

The setting unit 13 of the power adjustment device 1 may set the target power device based on the power supply and demand balance predicted in another device, for example. In this case, the power adjustment device 1 does not need to include the prediction unit 12. That is, the power adjustment device 1 does not need to predict the power supply and demand balance.

The power adjustment device 1 of the present disclosure has the following configuration.

[1] A power adjustment device for adjusting a supply and demand balance of power in a power system comprising one or more power devices each of which is at least one of a storage battery and a load, comprising: a setting unit that sets at least one of the power devices as a target power device, for which operation control related to power is possible, based on the supply and demand balance predicted; and an adjustment unit that adjusts the supply and demand balance by controlling an operation of the target power device.

[2] The power adjustment device according to [1], wherein, when it is predicted that an abnormality in the supply and demand balance will occur, the setting unit sets the target power device so as to resolve the abnormality in the supply and demand balance.

[3] The power adjustment device according to [1] or [2], wherein the setting unit sets the target power device so that an adjustment power amount that is adjustable by controlling the operation of the target power device is equal to or greater than a differential power amount, which is a difference between an amount of power scheduled to be supplied to the power system and an amount of power predicted to be demanded in the power system.

[4] The power adjustment device according to [3], wherein the setting unit sets the target power device so that a difference between the adjustment power amount and the differential power amount is minimized.

[5] The power adjustment device according to any one of [1] to [4], wherein the setting unit sets the target power device based on at least one of an amount of power charged and discharged in a storage battery and an amount of power consumed by a load.

[6] The power adjustment device according to any one of [1] to [5], wherein the power system comprises one or more storage batteries and one or more loads, and the setting unit sets the one or more storage batteries and the one or more loads as the target power devices.

[7] The power adjustment device according any one of [1] to [6], wherein the setting unit determines whether or not to set a load as the target power device based on an operating state of the load.

[8] The power adjustment device according to any one of [1] to [7], wherein the setting unit sets the target power device based on an instruction from a user of the power adjustment device.

In addition, the block diagrams used in the description of the above embodiment show blocks in functional units. These functional blocks (configuration units) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

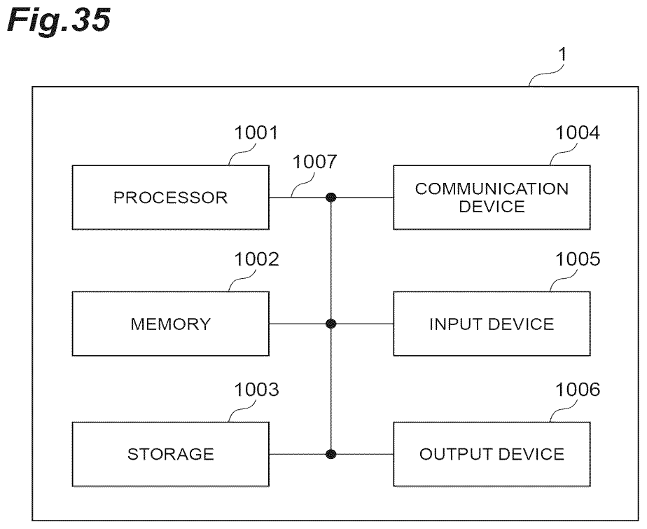

For example, the power adjustment device 1 and the like according to an embodiment of the present disclosure may function as a computer that performs processing of the power adjustment method of the present disclosure. FIG. 35 is a diagram showing an example of the hardware configuration of the power adjustment device 1 according to an embodiment of the present disclosure. The power adjustment device 1 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a unit, and the like. The hardware configuration of the power adjustment device 1 may include one or more devices for each device shown in the diagram, or may not include some devices.

Each function in the power adjustment device 1 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like. For example, the above-described prediction unit 12, setting unit 13, and adjustment unit 14 may be realized by the processor 1001.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. For example, the prediction unit 12, the setting unit 13, and the adjustment unit 14 may be implemented by a control program stored in the memory 1002 and operating in the processor 1001, or may be implemented similarly for other functional blocks. Although it has been described that the various kinds of processes described above are performed by one processor 1001, the various kinds of processes described above may be performed simultaneously or sequentially by two or more processors 1001. The processor 1001 may be implemented by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to implement the radio communication method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium described above may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module. The communication device 1004 may be configured to include, for example, a high-frequency switch, a duplexer, a filter, a frequency synthesizer, and the like in order to realize at least one of frequency division duplex (FDD) and time division duplex (TDD), for example. For example, the above-described prediction unit 12, setting unit 13, and adjustment unit 14 may be realized by the communication device 1004.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the word weight calculation system 1 may be configured to include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be implemented by using at least one of these hardware components.

The notification of information is not limited to the aspects/embodiments described in the present disclosure, and may be performed using other methods.

Each aspect/embodiment described in the present disclosure may be applied to at least one of systems, which use LTE (Long Term Evolution), LTE-A (LTE-Advanced), SUPER 3G, IMT-Advanced, 4G (4th generation mobile communication system), 5G (5th generation mobile communication system), FRA (Future Radio Access), and NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and next-generation systems extended based on these. In addition, a plurality of systems may be combined (for example, a combination of 5G and at least one of LTE and LTE-A) to be applied.

In the processing procedure, sequence, flowchart, and the like in each aspect/embodiment described in this disclosure, the order may be changed as long as there is no contradiction. For example, for the methods described in the present disclosure, elements of various steps are presented using an exemplary order. However, the present invention is not limited to the specific order presented.

Information or the like that is input and output may be stored in a specific place (for example, a memory) or may be managed using a management table. The information or the like that is input and output can be overwritten, updated, or added. The information or the like that is output may be deleted. The information or the like that is input may be transmitted to another device.

The judging may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, in a case where software is transmitted from a website, a server, or other remote sources using at least one of the wired technology (coaxial cable, optical fiber cable, twisted pair, digital subscriber line (DSL), and the like) and the wireless technology (infrared, microwave, and the like), at least one of the wired technology and the wireless technology is included within the definition of the transmission medium.

The information, signals, and the like described in the present disclosure may be expressed using any of a variety of different technologies. For example, data, instructions, commands, information, signals, bits, symbols, and chips that can be referred to throughout the above description may be represented by voltage, current, electromagnetic waves, magnetic field or magnetic particles, light field or photon, or any combination thereof.

In addition, the terms described in this disclosure and the terms necessary for understanding this disclosure may be replaced with terms having the same or similar meaning.

The terms “system” and “network” used in the present disclosure are used interchangeably.

In addition, the information, parameters, and the like described in the present disclosure may be expressed using an absolute value, may be expressed using a relative value from a predetermined value, or may be expressed using another corresponding information.

The names used for the parameters described above are not limiting names in any way. In addition, equations and the like using these parameters may be different from those explicitly disclosed in the present disclosure.

The term “determining” used in the present disclosure may involve a wide variety of operations. For example, “determining” can include considering judging, calculating, computing, processing, deriving, investigating, looking up (search, inquiry) (for example, looking up in a table, database, or another data structure), and ascertaining as “determining”. In addition, “determining” can include considering receiving (for example, receiving information), transmitting (for example, transmitting information), input, output, and accessing (for example, accessing data in a memory) as “determining”. In addition, “determining” can include considering resolving, selecting, choosing, establishing, comparing, and the like as “determining”. In other words, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, and printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

“Means” in the configuration of each device described above may be replaced with “unit”, “circuit”, “device”, and the like.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, in a case where articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separate” and “coupled” may be interpreted similarly to “different”.

### REFERENCE SIGNS LIST

1 . . . power adjustment device, 3 . . . storage battery, 4 . . . load, 5 . . . power supply source, 6 . . . power system, 11 . . . storage unit, 12 . . . prediction unit, 13 . . . setting unit, 14 . . . adjustment unit, 20 . . . external database, 1001 . . . processor, 1002 . . . memory, 1003 . . . storage, 1004 communication device, 1005 . . . input device, 1006 . . . output device, 1007 . . . bus.

1. A power adjustment device for adjusting a supply and demand balance of power in a power system comprising one or more power devices each of which is at least one of a storage battery and a load, comprising processing circuitry configured to:
set at least one of the power devices as a target power device, for which operation control related to power is possible, based on the supply and demand balance predicted; and
adjust the supply and demand balance by controlling an operation of the target power device.

2. The power adjustment device according to claim 1,
wherein, when it is predicted that an abnormality in the supply and demand balance will occur, the processing circuitry is configured to set the target power device so as to resolve the abnormality in the supply and demand balance.

3. The power adjustment device according to claim 1,
wherein the processing circuitry is configured to set the target power device so that an adjustment power amount that is adjustable by controlling the operation of the target power device is equal to or greater than a differential power amount, which is a difference between an amount of power scheduled to be supplied to the power system and an amount of power predicted to be demanded in the power system.

4. The power adjustment device according to claim 3,
wherein the processing circuitry is configured to set the target power device so that a difference between the adjustment power amount and the differential power amount is minimized.

5. The power adjustment device according to claim 1,
wherein the processing circuitry is configured to set the target power device based on at least one of an amount of power charged and discharged in a storage battery and an amount of power consumed by a load.

6. The power adjustment device according to claim 1,
wherein the power system comprises one or more storage batteries and one or more loads, and
the processing circuitry is configured to set the one or more storage batteries and the one or more loads as the target power devices.

7. The power adjustment device according to claim 1,
wherein the setting unit determines-processing circuitry is configured to determine whether or not to set a load as the target power device based on an operating state of the load.

8. The power adjustment device according to claim 1,
wherein the processing circuitry is configured to set the target power device based on an instruction from a user of the power adjustment device.

9. The power adjustment device according to claim 2,
wherein the processing circuitry is configured to set the target power device so that an adjustment power amount that is adjustable by controlling the operation of the target power device is equal to or greater than a differential power amount, which is a difference between an amount of power scheduled to be supplied to the power system and an amount of power predicted to be demanded in the power system.
